(19) United States
(12) Patent Application Publication
(10) Pub. No.: US 2026/0024316 A1
(43) Pub. Date: Jan. 22, 2026

(54) OBJECT DETECTION AND IMAGE SEGMENTATION FOR EUKARYOTIC CELLS

(71) Applicant: RUTGERS, THE STATE UNIVERSITY OF NEW JERSEY, New Brunswick, NJ (US)

(72) Inventors: Dongfang LIU, Millburn, NJ (US); Alireza NAGHIZADEH, Newark, NJ (US); Dimitris METAXAS, Princeton, NJ (US)

(21) Appl. No.: 18/996,566

(22) PCT Filed: Jul. 19, 2023
(86) PCT No.: PCT/US2023/028125

§ 371 Date: Jan. 17, 2025

Related U.S. Application Data
(60) Provisional application No. 63/390,489, filed on Jul. 19, 2022.

(51) Int. Cl. G06V 10/774; G06T 7/00; G06T 11/00; G06V 10/26; G06V 10/30; G06V 10/82; G06V 20/69

(52) U.S. Cl. CPC G06V 10/774; G06T 7/0012; G06T 11/00; G06V 10/273; G06V 10/30; G06V 20/695; G06T 2207/10056; G06T 2207/20081; G06T 2207/20084; G06T 2207/30024; G06T 2210/12; G06T 2210/41; G06V 10/82

(57) ABSTRACT

A method of generating artificial images for medical evaluation of eukaryotic cells can include extracting each instance of single-cells in an image of eukaryotic cells; extracting each instance of multi-cells in the image of eukaryotic cells; generating a background image from the image of eukaryotic cells; selecting a set of cells from the extracted single-cells and the extracted multi-cells; applying at least one augmentation technique to each cell in the set of cells to generate augmented cells; and generating an artificial image of eukaryotic cells using the augmented cells and the background image.

### CROSS-REFERENCE TO RELATED APPLICATIONS

This application is the U.S. National Stage Application of International Application No. PCT/US2023/028125, filed Jul. 19, 2023, which claims the benefit of U.S. Provisional Patent Application Ser. No. 63/390,489, filed Jul. 19, 2022, which are hereby incorporated by reference in their entirety.

### BACKGROUND

There exist many powerful architectures for object detection and instance segmentation of both biomedical and natural images. However, a difficulty arises in the ability to create training datasets that are large and well-varied. The importance of this subject is nested in the amount of training data that artificial neural networks need to accurately identify and segment objects in images and the infeasibility of acquiring a sufficient dataset within the biomedical field.

In particular, the ability to image, extract and study cells is essential to various research areas within the medical field. Advancements in high-resolution fluorescent microscopy have allowed medical professionals access to a more detailed visualization of cells and their interactions. A prime example is within immunotherapy, where there exists great importance to assess the efficacy of different treatments for fatal illnesses such as cancer, or more contemporarily, HIV/AIDS. Automated analysis of cellular images enables medical researchers to avoid time-consuming quantification, vastly improving the speed at which it takes to quantify reproducible mass data. The development of strong artificial neural networks for instance segmentation and object detection should naturally accompany the automation process.

However, the large datasets required to train models of Artificial Neural Networks (ANNs) greatly slows down researchers due to the naturally lengthy process of acquiring ground truth images. In the translational and basic biomedical research, the well-annotated datasets are critical for machine learning algorithms. Particularly, the detection and segmentation of eukaryotic cells used for intensity quantification of these cells require large manually annotated microscopical datasets for artificial neural networks (ANNs). Creating training data from microscopical images requires expertise and precision to separate nuclei cells.

Unfortunately, current methods in machine learning which deal with artificially augmenting training data such as different forms of Generative Adversarial Networks (GANs) do not deal with generating instance segmentation masks for the objects. They also have other problems that make them unsuitable for generating training data in medical fields. To properly train GAN networks, there is usually need for a large set of training data, which is not always available in microscopical nuclei imaging.

Another issue that current models of data augmentation may have with nuclei cell images originates from the nature of this type of data. Given that medical imaging deals with highly sensitive data, having uncontrolled, noisy, and unreliable artificial images can potentially lead to disastrous outcomes. For instance, in natural images, creating unidentified objects that look real is always exciting. However, for immunotherapists that are treating cancer patients, using such training sets may result in not correctly evaluating an immune response within a cancer patient. For example, physicians use the images of chimeric antigen receptor (CAR) immunological synapse (IS) quality using ANNs to predict the efficacy of certain CAR-T cells in clinics. The existence of unidentified, synthesized CAR IS objects in the training images can result in incorrectly evaluating an immune response for a cancer patient.

Thus, there is a need for systems and methods to generate artificially augmented images of eukaryotic cells in a manner that is also generates accurate masks of the objects within the images.

### BRIEF SUMMARY

Improved object detection and image segmentation for eukaryotic cells is described, which is suitable for generating training data, particularly of eukaryotic cells, for medical-related machine learning systems.

A method of generating artificial images for medical evaluation of eukaryotic cells can include extracting each instance of single-cells in an image of eukaryotic cells; extracting each instance of multi-cells in the image of eukaryotic cells; selecting a set of cells from the extracted single-cells and the extracted multi-cells; applying at least one augmentation technique to each cell in the set of cells to generate augmented cells; and generating an artificial image of eukaryotic cells using the augmented cells. The method can further include generating a background image from the image of eukaryotic cells, the artificial image being generated using the augmented cells and the background image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a method of image creation for generating training data for image segmentation of eukaryotic cells.

FIG. 2 illustrates a process pipeline of a method of image creation.

FIG. 3 illustrates an autoencoder pipeline.

FIGS. 4A-4C illustrate a process pipeline of a method of image creation including creation of background images for the artificial images.

FIGS. 5A-5F show removal of cells from a real image to create an artificially generated background.

FIGS. 6A-6F show placement of cells on an artificially generated background.

FIGS. 7A-7C show single-cell image generation of CAR-T and Kaggle datasets.

FIGS. 8A-8C show multi-cells image generation on CAR-T and Kaggle datasets.

FIGS. 9A-9G show cell nuclei image generation on CAR-T and Kaggle datasets.

FIGS. 10A-10C show cell nuclei image generation on CAR-T, Kaggle, and Neural datasets.

FIG. 11 shows a sample of an artificially generated Neural dataset (first row) with its respective instance segmentation (second row).

FIG. 12 shows a real sample from the Neural dataset (first row) with its respective instance segmentation (second row).

FIG. 13 shows a sample of an artificially generated CAR-T dataset (first row) with its respective instance segmentation (second row).

FIG. 14 shows a real sample from the CAR-T dataset (first row) with its respective instance segmentation (second row).

FIG. 15 shows a sample of an artificially generated Kaggle dataset (first row) with its respective instance segmentation (second row).

FIG. 16 shows a real sample from the Kaggle dataset (first row) with its respective instance segmentation (second row).

FIG. 17 shows single-cell real images on CAR-T, Neural, and Kaggle datasets.

FIG. 18 shows single-cell image generation on CAR-T, Neural, and Kaggle datasets.

FIG. 19 shows multi-cell real images on CAR-T, Neural and Kaggle datasets.

FIG. 20 shows multi-cell image generation on CAR-T, Neural and Kaggle datasets.

FIG. 21 shows a comparison between complete image generation of Neural dataset.

FIG. 22 shows images of the original CAR-T dataset and the original Kaggle dataset.

FIG. 23 shows a sample using different forms of augmentation techniques on the cells.

FIG. 24 shows a sample using different forms of augmentation techniques on the cells.

FIG. 25 shows a sample of the final images created from the proposed method (128×128 for each sample) using the Neural dataset.

FIG. 26 shows a sample of the final images created from the real images (128×128 for each sample) using the Neural dataset.

FIG. 27 shows a sample of the final images created from the StyleGAN2-Diff method (128×128 for each sample) using the Neural dataset.

FIG. 28 shows a sample of the final images created from the StyleGAN2-Diff method (128×128 for each sample) using the CAR-T dataset.

FIG. 29 shows a sample of the final images created from the StyleGAN2-Diff method (128×128 for each sample) using the Kaggle dataset.

FIG. 30 shows a sample of the final images created from the real images (128×128 for each sample) using the CAR-T dataset.

FIG. 31 shows a sample of the final images created from the real images (128×128 for each sample) using the Kaggle dataset.

FIG. 32 shows a table of the Ap, AP50, AP75, and APS scores of bounding box (bbox) detection on CAR-T, Kaggle, and Neural datasets.

### DETAILED DESCRIPTION

Improved object detection and image segmentation for eukaryotic cells is described, which is suitable for generating training data, particularly of eukaryotic cells, for medical-related machine learning systems.

One of the most exciting, recent advancements in medical sciences is automating the analysis of microscopical images with machine learning tools. Specifically, many of these images are related to detection of nuclei cells. Creating well-varied and accurate datasets that are needed to train machine learning tools is time-consuming, costly, and labor-intensive. Through techniques described herein, it is possible to generate artificial cell nuclei microscopical images along with their correct instance segmentation masks. The resulting images can be used to assist in accessing higher generalization capabilities of artificial neural networks.

The described techniques can be used to reliably automate the ground truth generation of nuclei cells, which can prevent common human errors. In addition, by being able to generate a huge number of training data, it is possible to help the learning of artificial neural networks for related biological fields in a way that is not possible with current technologies.

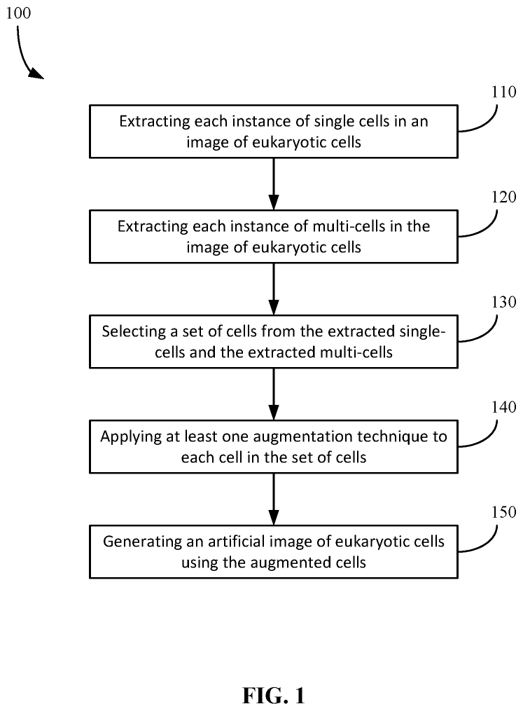

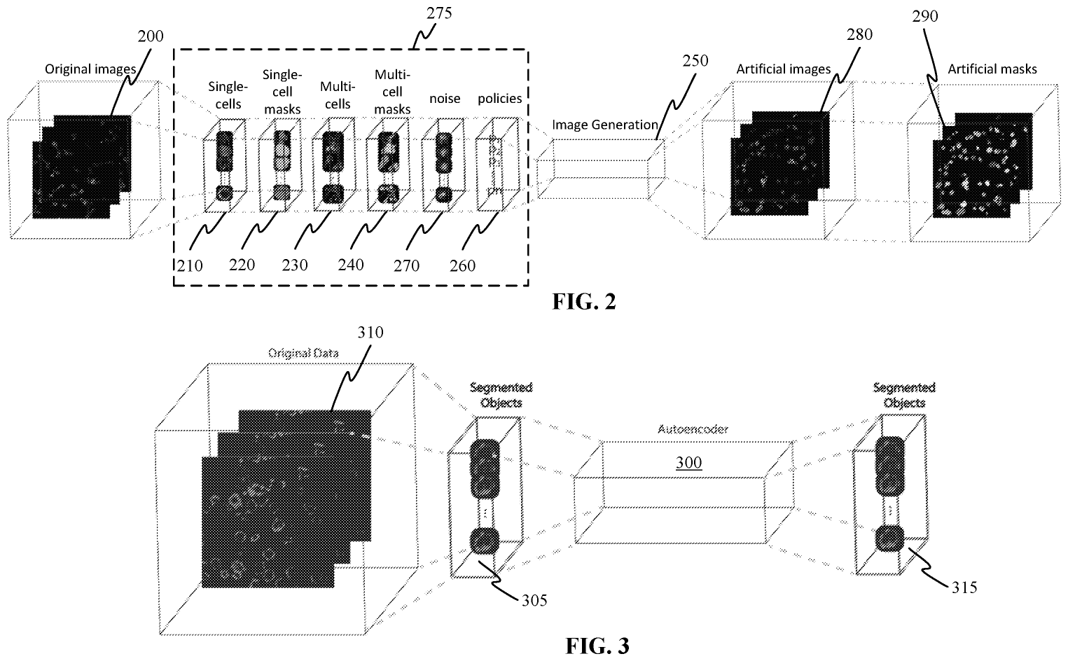

FIG. 1 illustrates a method of image creation for generating training data for image segmentation of eukaryotic cells and FIG. 2 illustrates a process pipeline of a method of image creation.

Referring to FIG. 1, a method 100 of image creation includes extracting (110) each instance of single cells in an image of eukaryotic cells and extracting (120) each instance of multi-cells in the image of eukaryotic cells. The extracting (110) of each instance of single-cells can include identifying each instance of single-cells in the image of eukaryotic cells, labelling each instance of single-cells as a single-cell, and storing each instance of single-cells in a single-cell resource. The extracting (120) of each instance of multi-cells can include identifying each instance of multi-cell groupings in the image of eukaryotic cells, labelling each instance of multi-cells as a multi-cell, and storing each instance of multi-cells in a multi-cell resource.

For example, as can be seen in FIG. 2, an initial set of original images 200 can be segmented to extract cells and then sorted between two categories, the first being singular cells that can be easily distinguished from other cells and the second type being multi-cells, resulting in a set of single cells 210 and corresponding single-cell masks 220 and a set of multi-cells 230 and corresponding multi-cell masks 240. The original images 200 include instance segmentation masks, which may have been labeled by experts within the biomedical field or labeled by automated methods.

A multi-cell is a segmentation object consisting of multiple cells with intersecting bounding boxes. Multi-cells are identified as joint cells that more commonly suffer from the impurities such as low contrast of cell boundaries, background noise, adhesion, and cell clustering. Advantageously, by separately extracting (and using) multi-cells instead of generating multi-cells from single cells, it is possible to generate cells that have the natural properties of joint cells found in the data. Similarly, by separately extracting (and using) single-cells instead of generating single-cells from joint cells, errors such as unnatural imagery from using ambiguous borders of joint cells in creating single cells can be avoided. In some cases, when extracting the single-cells and multi-cells objects from the original images, those that are too close to the boundaries of the original images are ignored.

Returning to FIG. 1, method 100 includes selecting (130) a set of cells from the extracted single-cells and the extracted multi-cells; and applying (140) at least one augmentation technique to each cell in the set of cells to generate augmented cells.

In operation 130, the set of cells selected from the extracted single-cells and the extracted multi-cells can be selected according to a distribution policy. The distribution policy can be based on mimicking the distribution of the number of cells (and noise) within the training data and the ratio of multi-cells to singular cells. In some cases, all the extracted single-cells and/or extracted multi-cells are selected for augmentation. In some cases, a subset of the extracted single-cells and/or a subset of extracted multi-cells are selected. In some cases, the selection of cells for the set of cells is random.

In operation 140, the at least one augmentation technique can be a pre-determined selection of a set of augmentation techniques, referred to as an augmentation policy. That is, the at least one augmentation technique applied to each cell in the set of cells corresponds to a particular augmentation policy of pre-determined selection of a set of augmentation techniques. Data augmentation is a technique used to extrapolate a dataset through the application of standard transformations onto image data. In this method, normal transformations are selected and applied to images through a pre-processing step. Augmentation utilizes policies, where each policy contains information on the different standard augmentation techniques that will be utilized, the probabilities of applying the technique, and the magnitude of the operation.

The set of augmentation techniques of a particular augmentation policy can be selected from the following 11 types of augmentation techniques.
FlipLR—where the image is flipped along the vertical axis.
FlipUD—where the image is flipped along the horizontal axis.
AutoContrast—where the contrast of the image is increased.
Equalize—where the histogram of the image is equalized.
Rotate—where the image is rotated by a certain number of degrees.
Posterize—where the number of bits for each pixel in the image is reduced.
Contrast—where the contrast of the image is changed.
Brightness—where the brightness of the image is adjusted.
Sharpness—where the sharpness of the image is adjusted.
Smooth—where the image is smoothed (e.g., low-pass filtering).
Resize—where the image resolution is changed.

Of course, it should be understood that more or fewer techniques may be available as part of the types of augmentation techniques from which the set is selected. In addition, a set may contain a single augmentation technique or any number of augmentation techniques (e.g., up to 11 different types of techniques when selecting from the 11 types of augmentation techniques) such that the augmentation policies can include one or more augmentation techniques, depending on the corresponding set. In addition, certain policies may contain the same one or more types of techniques, but with different magnitudes. In some cases, a subset of the augmentation techniques is used (i.e., fewer than the 11 different types) in order to maintain the integrity of the original cells.

To identify the particular augmentation policy of a pre-determined selection of a set of augmentation techniques that is applied to each extracted single-cell and each extracted multi-cell, potential policies of combinations of augmentation techniques are scored and ranked. A specified number of potential policies are then made available for use to generate augmented cells. In some cases, the highest ranking potential policy is applied to generate the augmented cells in operation 140. In some cases, two or more of the highest ranking potential policies are applied to generate the augmented cells in operation 140 such that there will be more augmented cells available for generating the artificial image than original cells in the set of cells.

Automated augmentation finds the best sets of augmentation policies through an efficient search algorithm that aids in the determination of the strongest sets of transformations that improve accuracy in computer vision tasks. Search algorithms, such as Greedy AutoAugment (such as in synchronous mode), can be used to find the strongest augmentation policies in the search space of policies using a specified scoring criterion. A high-scoring augmentation policy transforms an image while maintaining its authentic properties, avoiding obscure augmentations.

To identify highest ranked policies, an autoencoder such as described with respect to FIG. 3 can be used. An autoencoder neural network is an unsupervised learning method, which sets the target values to be equal to their given inputs, estimating an identity function. The identity function learns to compress and encode data for the purpose of reconstructing the data through the reduced encoded representation. Given real image data, this function learns the distribution of the data and gains the ability to estimate the realisticity of artificial data. It is important when an augmentation takes place, the policy does not alter the given nuclei cell to an unrecognizable state. The AutoEncoder attempts to learn an identity function that maps an object to itself, minimizing reconstruction error between inputs and its respective outputs. The features found through this neural network helps to retain a level of authenticity when manipulating an object. The best-performing sub policies can then be used as final policies applied in operation 140.

In a specific implementation, a Wasserstein Autoencoder is used. A Wasserstein Autoencoder chooses to minimize a Wasserstein distance, which is a distance function between two probability functions within a metric space, and provides a suitable scoring system for Greedy AutoAugment (described in more detail below, which ranks different combinations of sub-policies.

In some implementations, instead of using an autoencoder, diffusion methods may be used to identify highest ranked policies of a set of augmentation techniques that can be applied to each extracted single-cell and each extracted multi-cell. Of course, other neural network algorithms may be used.

Method 100 further includes generating (150) an artificial image of eukaryotic cells using the augmented cells. The resulting artificial image of eukaryotic cells includes artificial cell nuclei microscopical images along with their correct instance segmentation masks.

For example, referring again to FIG. 2, an image generation process 250 can involve selecting a set of cells from the single-cells 210 and the multi-cells 230 and then applying augmentation policies 260 to the set of cells. A set of noise 270 can be obtained for use in the image generation process 250. Adding noise helps to avoid overfitting within the created datasets. Each of the cell and mask objects (e.g., 210, 220, 230, 240) along with the policies 260 and noise 270 can be stored in a suitable storage resource 275. Storage resource 245 can be a single storage device or a plurality of storage devices. In addition, storage resource 245 can conceptually be separate resources for the various object types, noise, and policies, or be a single resource with a suitable data structure or data structures for maintaining the different information.

When creating the artificial images 280 from the image generation process 250, the distribution of the number of cells (and noise 270) within the training data and the ratio of multi-cells to singular cells can be mimicked. For example, let j denote the mode of the distribution representing the number of cells found within the original images 200, then j policies (of the n available policies 260) are selected from the Greedy AutoAugment search algorithm and applied to j original cells. These newly augmented cells are then applied in a controlled manner onto a blank image, avoiding overlaps while maintaining the ratio between multi and singular cells.

This image generation process 250 (with application of augmentation policies 260 and noise 270) is also applied to the corresponding masks of the cell objects (e.g., from the single-cell masks 220 and the multi-cell masks 240). Thus, creating an artificial image with natural properties and complete segmentation masks (e.g., complete ground truth information). The image generation process can be performed until r images are generated (e.g., the artificial images 280 and artificial masks 290) with a matching distribution to the number of cells found within the original data (e.g., the original images 200).

As previously mentioned, multi-cells are used to generate augmented multi-cells and single-cells are used to generate augmented single-cells such that when a multi-cell is placed inside a frame of an artificial image, that multi-cell is selected from the separated collection of multi-cells 230 images and when a single-cell is placed inside the frame of the artificial image, the single cell is selected from the separated collection of single-cell 210 images.

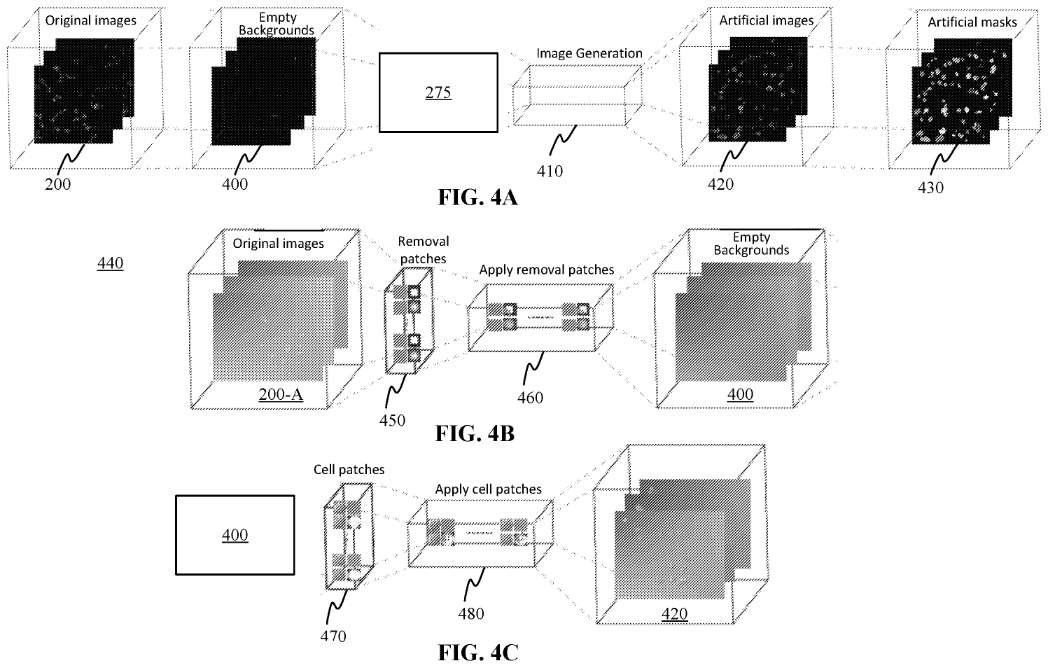

Returning again to FIG. 1, generating (150) the artificial image of eukaryotic cells using the augmented cells can include placing a selection of the augmented cells on a background image. The selection of the augmented cells may be all the augmented cells or a subset of the augmented cells. In some cases, the selected augmented cells are placed randomly (or pseudorandomly) on the background image. In some cases, such as described with respect to FIGS. 4A and 4B, the method 100 can further include creating the background image from the image of eukaryotic cells.

FIG. 3 illustrates an autoencoder pipeline. Referring to FIG. 3, the overall distribution of the individual cells can be determined using an AutoEncoder 300 trained to estimate an identity function, ƒ(Sᵢ)≈Sᵢ for i∈[0, n], where a set of instance segmented objects S=(x₀, . . . , xₙ) is defined as an initial set of single-cells and multi-cells, with an infinitely large search space, P, containing different augmentation policies. A goal is to find the best augmentation techniques that will output the most naturalistic nuclei images while maintaining complete segmentation masks.

The AutoEncoder 300 attempts to learn the function ƒ(Sᵢ), where Sᵢ is a set of segmented cells that maps Sᵢ to itself. Here, Sᵢ contains all of the segmented objects 305 from the single-cells (e.g., single-cells 210 of FIG. 2) and multi-cells (e.g., multi-cells 230 of FIG. 2). The segmented objects 305 (the single-cells and the multi-cells) are obtained from the original training data 310 similar to that described with respect to FIG. 2 (for extracting single-cells and multi-cells). These extracted cells are separated as sampled objects (Sᵢ) (the segmented objects 305). The AutoEncoder 300 is used to map Sᵢ (represented in segmented objects 305) to Sᵢ (represented in segmented objects 315) to find the distribution of Sᵢ.

After training for a specific number of epochs, the next step is to use the trained AutoEncoder to create a criterion for the purpose of ranking different augmentation policies as described above with respect to the augmented cell generation process 140.

For example, to determine the quality of a single policy, the policy is applied to all members of Sᵢ. When a cell is augmented and passed through the AutoEncoder 300 and maps to the same exact cell without applying the policy, its output can evaluate the quality of that policy. With this mechanism, it is possible to make sure that the original cells can be changed but maintain their integrity. The purpose of this is when the augmentation takes place. the policy should not alter the cell to an unrecognizable state. In the searching phase, the accuracy of ƒ(Sᵢ) is passed as the scoring criterion for the Greedy Search to rank every explored policy.

The AutoEncoder gives a high-level evaluation of the quality of the augmented policies and creates the scoring criterion for Greedy AutoAugment.

Greedy AutoAugment is an efficient search algorithm that finds the best augmentation policies within an arbitrarily large sample space. After finding the best policies for single-cells and multi-cells objects, the cells accept policies and can be used to generate the artificial image as described with respect to operation 150 of FIG. 1 and operation 250 of FIG. 2.

As mentioned above, a policy is used to perform data augmentation on an image. Each policy P (e.g., of policies 260 of FIG. 2) includes the augmentation technique, the magnitude of the operation, and the probability. Therefore, a search mechanism for finding the best augmentation techniques is a search space that should consider all possible combinations of these three elements. Example augmentation techniques include those described above. The magnitude is the degree to which an operation is applied. For instance, in the rotation augment, the magnitude specifies how much an image is rotated. Finally, the third element specifies the probability of applying the augmentation to the image.

Search Space. The search space, S, consists of m sequential image operations. Each image operation can be defined as a sub-policy that contains information of two hyperparameters, the probability of applying the operation, and its magnitude. The range of probabilities and magnitude include two discrete variables within uniform spaces, nₚ, and nₘ. In this manner, a discrete search algorithm may be utilized to find the best sub-policies. The size of the search space for nₒ operations can be denoted as nₛ=(nₒ×nₚ×nₘ)^{l}.

Score. A score is given to each sub-policy through the utilization of the autoencoder 300 that compares how well an augmented cell maps to its original variant. The score is a metric that measures the performance of a policy by passing a given cell through a trained Wasserstein AutoEncoder. The degree of accuracy provided from this method measures the closeness of an image to the original cell dataset and is passed to the search algorithm to select the strongest augmentation policies.

Search Algorithm. The size of the search space of potential augmentation policies grows exponentially due to the different combinations of varying transformations, their probability of applying a policy, and magnitude. This explains the impracticality of a brute force approach. In order to make the search process feasible, a greedy search is utilized. A reduced search space is traversed where each augmentation policy contains only a single sub-policy in the beginning, l=1. In this reduced space, the best probability and magnitude for each of the varying image operations is identified through the scoring criterion mentioned earlier. Similarly, the best variables are identified for a second sub-policy, l=2. For every found policy within the first stage, the best combinations of image operations are identified with their associated probabilities and magnitudes. This process is repeated until l=lₘₐₓ, the maximum number of sub-policies. All policies are then sorted via their scores, and the top b augmentations are selected to create the artificial training set.

In particular, before searching for the best policy, the space of probabilities and the magnitudes are discretized. The discretization of probabilities uses eleven values within uniform space (based on the eleven augmentation techniques described above), and the discretization of magnitudes uses ten values within uniform space. With this setting, the search space is simply (20×10×11). This search space is defined to consider all possible combinations of elements in one sub-policy (the first search layer). If the search space is expanded in order to find all the possible combinations for two sub-policies, the search space increases its size to (20×10×11)² (two search layers). Continuously, it is possible to expand the search space for more layers infinitely. In general, the search space is defined as (20×10×11)^{l}, where l is the number of layers within the search space.

To reduce the search space. Greedy AutoAugment considers the probability value of one, for all augmentation techniques. Additionally, instead of considering all possible combinations, only the best combinations from the strongest sub policies are considered. In other words, a greedy search algorithm is used, and expanding the search layers occurs only when it is required. Accordingly, the new number of the possibilities is defined as follows

$${\sum }_{1}^{k} ( {t}_{n} \times {m}_{n} ) .$$

In this notation, k is an arbitrary integer number, which indicates the number of iterations the algorithm is allowed to perform within the search. The t and m variables represent the augmentation technique and magnitude. Respectively, tₙ and mₙ are the maximum values for t and m. To augment the data, a selection of the policies are used among all of the searched policies based on a scoring criterion. With the selected policies, the training data can then be expanded with the new augmented data as much as is required.

FIGS. 4A-4C illustrate a process pipeline of a method of image creation including creation of background images for the artificial images. Referring to FIG. 4A. background images 400 can be obtained from original images 200 and used in image generation 410. Similar to that described with respect to FIG. 2 using data (e.g., the cell and mask objects, 210, 220, 230, 240 obtained from original images 200, along with the policies 260 and noise 270) on the storage resource 275 (and operation 150 of FIG. 1), the image generation process 410 for generating the artificial image 420 (and associated artificial mask 430) of eukaryotic cells using the augmented cells can include placing a selection of the augmented cells on a background image.

As mentioned above, the background image upon which the artificial image is formed can be created from the image of eukaryotic cells. This supports using color (and grayscale) backgrounds similar to that found in the original image (as opposed to a solid single-color background).

Referring to FIG. 4B, a process 440 of creating empty backgrounds 400 from original images 200-A is shown. To create natural background images, it is possible to take advantage of the images acquired from the existing training datasets. Here, removal patches 450 are created and applied (460) to an original image to generate the empty background image. The removal patches 450 can include a bounding box for each segmented object (which may be single-cell object or multi-cell object), a masking image, and filter.

The process of creating empty backgrounds 400 from original images 200-A involves removing at least one instance of eukaryotic cells from the image of eukaryotic cell by generating a bounding box around at least one instance of a eukaryotic cell in the image of eukaryotic cells, wherein pixels of the image of eukaryotic cells inside the bounding box are inside pixels; and replacing values of the inside pixels with values corresponding to certain pixels found outside of the bounding box that are similar in values as bordering pixels of the bounding box to remove the at least one instance of the eukaryotic cell in the image of eukaryotic cells, wherein the certain pixels found outside of the bounding box are outside pixels.

For example, the process can include performing a method that includes generating a bounding box around the at least one instance of eukaryotic cells; selecting outside pixels, where the outside pixels are selected from pixels in the image of eukaryotic cells that are outside of the limits of the bounding box; comparing the outside pixels to at least one pixel in each of the bounding box corners; determining which of the outside pixels has the highest degree of similarity to each corner of the bounding box corners; selecting an inside pixel, where the inside pixel is selected from pixels within the at least one instance of eukaryotic cells; determining a closest corner, wherein the closest corner is the corner of the bounding box corners that is closest to the inside pixel; and replacing the inside pixel with the outside pixel having the highest degree of similarity to the closest corner. Replacing values of inside pixels with outside pixels can include for each inside pixel; selecting a predetermined number of outside pixels, comparing each of the predetermined number of outside pixels to pixels at corners of the bounding box to identify an outside pixel of the predetermined number of outside pixels that is most similar to the pixels at the corners of the bounding box, and replacing that inside pixel with the identified outside pixel.

The method can further include creating a masking image, where the masking image is an image with a black-colored background having a smaller, white area in the middle. wherein the masking image is the same size as the bounding box; and applying a Gaussian filter to the masking image to generate a filtered masking image. The filtered masking image is inserted in the same position as the bounding box; and an area of the image of eukaryotic cells is smoothed where the at least one instance of eukaryotic cells was removed.

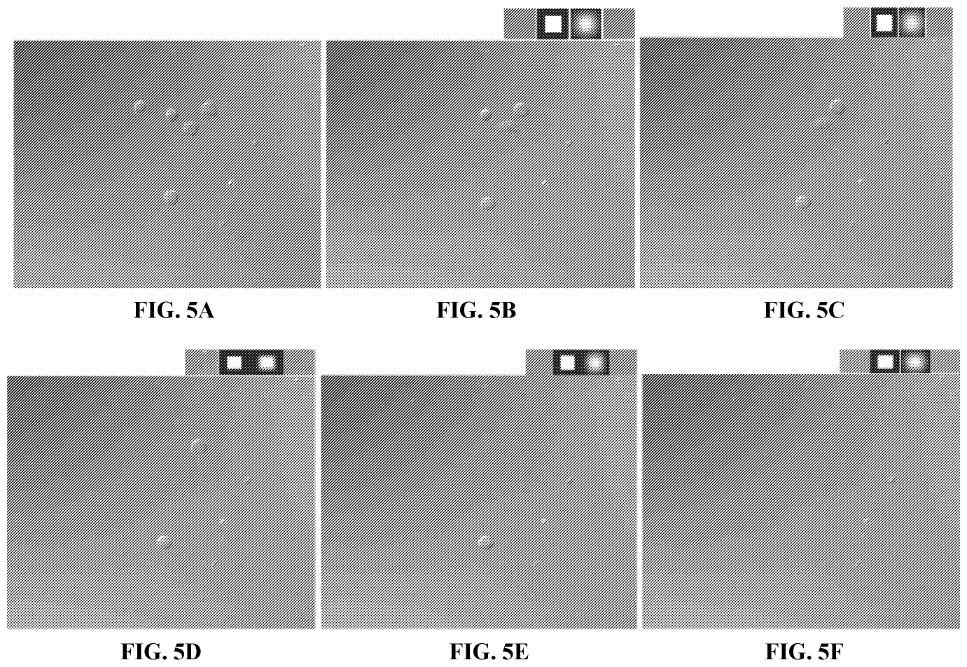

FIGS. 5A-5F show removal of cells from a real image to create an artificially generated background. FIG. 5A shows a sample of the real dataset from the Neural dataset. FIG. 5B shows the process of removing the first cell from the image. FIGS. 5C, 5D, 5E, and 5F show the results of removing four other cells.

In the original images, the existing cells need to be removed and then replaced with similar pixels that replicate the textures of the images. For example. FIG. 5A shows a sample from the Neural dataset in its original form with five cells that need to be removed. To remove the cells, segmented areas are used to create bounding boxes around the cells. If the bounding boxes are interconnected, a bigger bounding box is created to contain all the connected boxes. Next, the pixels inside each bounding box (inside pixels) need to be replaced by other pixels found outside of the bounding box (outside pixels) that are similar to the bordering pixels of the bounding box. For each inside pixel, n outside pixels are selected randomly and compared to the pixels of the upper-left corner, upper-right corner, lower-left corner, and lower-right corner of the bounding box. Among the selected pixels, the outside pixel that is most similar to the mentioned corners of the bounding box (evaluated using the mean Euclidean distance) is used to replace the inside pixel. This process is repeated until all inside pixels are replaced with outside pixels.

Through this method, cells are removed from the bounding boxes with a similar texture to the original background. However, there would still be notable discrepancies between the background and transformed bounding boxes. To impede these problems and create smoother textures, a masking technique is used that utilizes a Gaussian filter to replace the previous bounding box with a new one. In this method, an image with similar size to the bounding box is created with a black-colored background and a white rectangular area in the middle that acts as the mask. Next, a Gaussian filter is applied to disperse the white rectangle based on Gaussian distribution. The filtering process aids in a smooth transition between the textures of the background and the newly created bounding box. The new mask is finally used to copy the newly created bounding box onto the image. By repeating this process for each segmented cell, all of the cells are removed from the image. FIG. 5B shows the process of the removal of the first cell. At the top of each image in FIGS. 5B-5E, there are small rectangles that show the process needed to remove the cells and replace them with a smooth texture. From left to right, the steps include a newly created bounding box, the preliminary mask, a filtered version of the mask using a Gaussian Filter and, an applied filtered mask on the new bounding box. As can be seen in FIG. 5F, the pixel replacement process is effective and the removed areas are not distinguishable from the other background areas. The newly generated background can now be used to place augmented cells to create artificial images.

Referring to FIG. 4C, cells can be placed on the empty backgrounds during the image generation process 410 to generate the artificial images 420. The placement of cells on a background shares similar problems to the removal of cells. The brighter color spectrum found in the background and the cells signifies the differences in textures between them, which results in unnatural looking images. Accordingly, similar processes as performed to remove original cells can be carried out to create smooth transitions for the augmented cells.

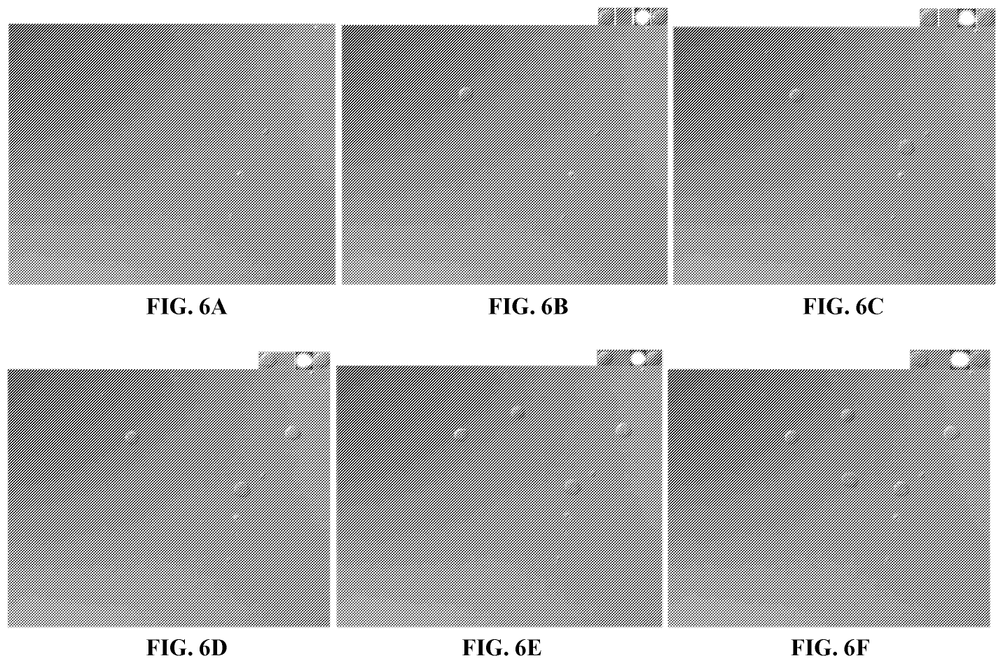

Indeed, cell patches 470 (which can involve the augmented single-cells and augmented multi-cells created as described with respect to FIGS. 1 and 2) can be applied (480) to the empty backgrounds 400 to create the artificial images 420. The method can include placing at least one cell from the selection of the augmented single-cells and the augmented multi-cells onto the background image by generating a bounding box around the at least one cell from the selection of the augmented single-cells and the augmented multi-cells; comparing pixels from four corners of the bounding box to pixels in the background image to determine a target location, where the target location is an area of the background image where the pixels in the background image have the highest degree of similarity to the pixels in the four corners of the bounding box; placing the at least one of the selection of the augmented single-cells and the augmented multi-cells in the target location; creating a cell masking image, where the cell masking image includes a black color background and a white area in the middle, wherein the white area is substantially the same shape as the at least one cell from the selection of the augmented single-cells and the augmented multi-cells; and applying a Gaussian filter to smooth the transition between texture of the background image and texture of the at least one cell from the selection of the augmented single-cells and the augmented multi-cells. An illustrative example is shown in FIGS. 6A-6F.

FIGS. 6A-6F show placement of cells on an artificially generated background. FIG. 6A shows an empty background (the artificially generated background shown in FIG. 5F). FIG. 6B shows the process of adding the first cell to the background. FIGS. 6C-6F show the process of adding four other cells. For FIGS. 6B-6F, each small rectangle at the top of the image shows the process performed to add a cell with a smooth transition. From left to right, process involves the original bounding box of the cell, the new bounding box taken from the new location of the cell, a filtered version of the manually segmented mask using a Gaussian filter, and an applied filtered mask on a searched bounding box from the background.

In detail for this example implementation, manually segmented areas can be used to create bounding boxes around each cell. If the bounding boxes are interconnected, a larger bounding box is generated to contain all the connected boxes. Next, the background image is searched for areas in the image that most closely resemble the pixel colors of the generated bounding boxes. For each bounding box, n number of x, y points are randomly selected. In order to select the best x, y pair, the upper-left corner, upper-right corner, lower left corner, and lower-right corner of the bounding box are compared with x, y, x+w, y+h pixels, in which w, h are the width and height of the bounding box. Among the selected x, y pairs, the x, y pair that is the most similar to the mentioned corners of the bounding box (evaluated using the mean Euclidean distance) is used to position the bounding box.

Finding a place where two textures have similar colors is helpful, but it is often not enough to avoid notable discrepancies between the backgrounds and the newly placed cells. To solve this problem and create a smooth transition between the cell and the background, a Gaussian Filter technique is applied. In order to place a cell in a background image, first, an image with similar size to the bounding box is created with a black color background and a white area in the middle that acts as a mask. Manual segmentation of the cell is then used to determine the shape of the white area. Next, a Gaussian filter is applied to disperse the white segmented area through a Gaussian distribution. The filtering process aids in a smooth transition between the texture of the background and the segmented cell. The new mask is then used to copy the separated bounding box from the cell onto the image. By repeating this process for all the segmented cells, any desired number of cells can potentially be placed on the image.

As can be seen in FIGS. 6B-6F, the adding process is effective, and the added area is not distinguishable from the original image sample.

The newly generated images can be used to train artificial neural networks. Note that for the segmentation images, the original unfiltered mask is used instead of Gaussian filter masks due to the Gaussian filter being less deterministic and may include areas other than the cells, which is not desired.

### Experiments and Evaluation of Results

The inventors use the proposed method to generate artificially augmented images on four prominent GAN models. The DCGAN is specifically designed to generate synthetic images for large-scale datasets. The small dataset Big-GAN (BigGAN-SD) is one of the first serious attempts to introduce GAN for small datasets. Data-Efficient GAN, which is more optimized for smaller datasets, was selected for the experiments. There are two variants of Data-Efficient GAN for two state-of-the-art methods, one is StyleGAN2, and the other is BigGAN. In the paper, the inventors call these two variants BigGAN-Diff and StyleGAN2-Diff. While these models are not designed to maintain instance segmentation masks for their image objects, they can still be used to compare the quality of the images created from our method.

Evaluation metrics. The inventors use two known evaluation metrics that are used for the GAN networks. Fréchet Inception Distance (FID) calculates the Fréchet distance between two multidimensional Gaussian distributions. This technique compares the distribution of the generated images, along with the mean and variances of the Gaussian distributions between artificial and original images. Kernel Inception Distance (KID) compares the two probability distributions by drawing samples independently from each distribution. This method improves FID and acts as a more reliable and unbiased estimator.

Experiment setup. All of the experiments were conducted on K80 NVIDIA graphic cards. As for the embedded deep neural networks for our method, the inventors used Pytorch (Paszke, A., et al. Pytorch: An imperative style, high-performance deep learning library. In Advances in Neural Information Processing Systems 32, pages 8024-8035. Curran Associates. Inc., 2019). For Greedy AutoAugment, the inventors used the implementation described in Naghizadeh. A., et al. Greedy AutoAugment, 2020 (arXiv:1908.00704 (cs.LG]) and for the AutoEncoder the inventors used the Wasserstein variation (see Tolstikhin. I., et al. Wasserstein auto-encoders, 2019 (arXiv:1711.01558 [stat.ML]) and Gulrajani, I., et al. Improved training of wasserstein gans, 2017 (NIPS'17 Proceedings of the 31^{st} International Converence on Neural Information Processing Systems, December 2017, pages 5769-5779; arXiv:1704.00028 [cs.LG]). For the experiments, all of the models are compared with their baseline released codes from the authors. The inventors did not alter the suggested configuration from the official papers. To reduce computations, the inventors searched the search space of augmentation policies within the maximum number of 20000 policies, in which the first 1000 policies are used. All of the GAN models were trained for 150000 epochs across all experiments.

The inventors mainly use two cell nuclei datasets containing microscopical images obtained from two different biological fields. The CAR-T cell dataset consists of 156 images at a resolution of 1024×1024. This dataset was collected by Rutgers Cancer Institute of New Jersey using microscope system AIR HD25 (Nikon, Japan), which provides a 25 mm field of view. The second dataset is the Kaggle 2018 Data Science Bowl (Bowl-18), which contains around 589 images that were acquired under a variety of conditions and vary in the cell type, magnification, and imaging modality (brightfield vs, fluorescence). A subset of 193 images with consistent attributes is used.

### Single-Cell Image Generation

Single-cell images are the most basic elements in the creation of complete artificial images. To create artificial single-cells, the inventors use extracted segmentations from experts. The cells should then transform from its original state to a new state using an augmented policy. The outcome is an artificial cell that can be used to create artificial images. In this section, the inventors measure the accuracy of these generated cells through the use of the evaluation methods discussed above (FID and KID). In other words, the inventors answer how much applying different augmentation policies affects the quality of single-cells. The results are shown in Table 1. The average scores for two datasets are reported. The numerical values apply to the average scores and are computed over three random sets of sample generation. In the table, the proposed method is referred to as Instance Aware Automatic Augmentation (IAAA).

TABLE 1
FID and KID scores for single cells

| | |
|---|---|
| Augmentation | Multi-cells |

| Methods | KID¹ | KID² | KID¹ | KID² |
|---|---|---|---|---|
| DCGAN | 227.06 | 235.60 | 0.2187 | 0.2042 |
| BigGAN-SD | 381.60 | 363.57 | 0.4765 | 0.3320 |
| BigGAN-Diff | 80.83 | 262.46 | 0.02591 | 0.4875 |
| StyleGAN2-Diff | 31.32 | 10.36 | 0.01173 | 0.0067 |
| IAAA | 8.37 | 23.32 | 0.00068 | 0.0212 |

¹represents a score using the CAR-T dataset,
²represents a score using the Kaggle dataset

Fréchet Inception Distance. The results show that the proposed method performs competitively compared to existing models. The best performing GAN model is StyleGAN2-Diff, which is outperformed by 17.6 with the proposed method using the CAR-T data. When using the Kaggle dataset, StyleGAN2-Diff scores 10.36, which is marginally better than the proposed method.

Kernel Inception Distance. The KID scores show that the proposed method has a higher score than StyleGAN2-Diff by 0.01105 using the CAR-T data. When using the Kaggle dataset, StyleGAN2-Diff scores 0.0067, which is better than the proposed method.

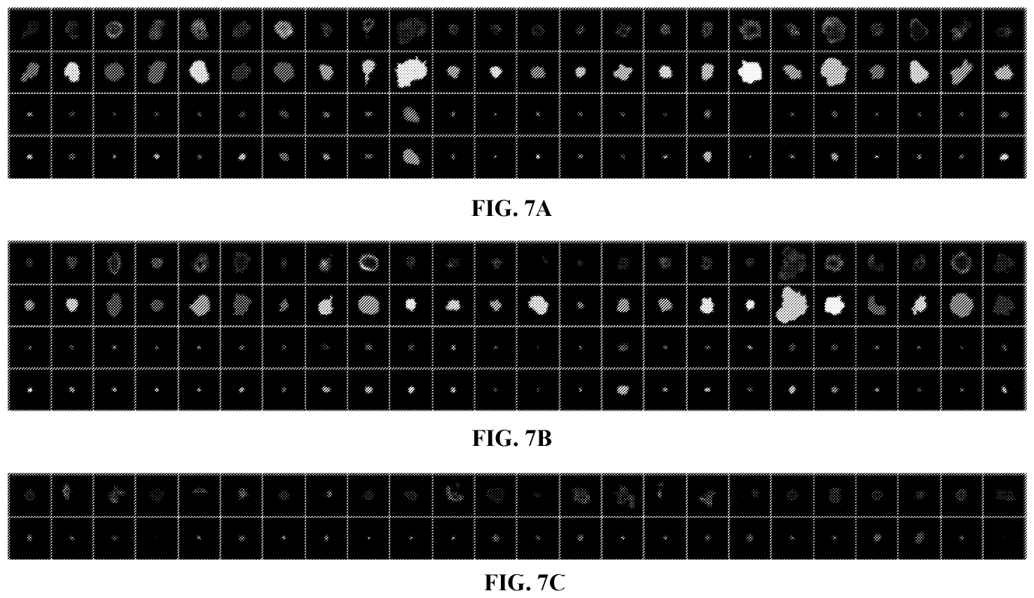

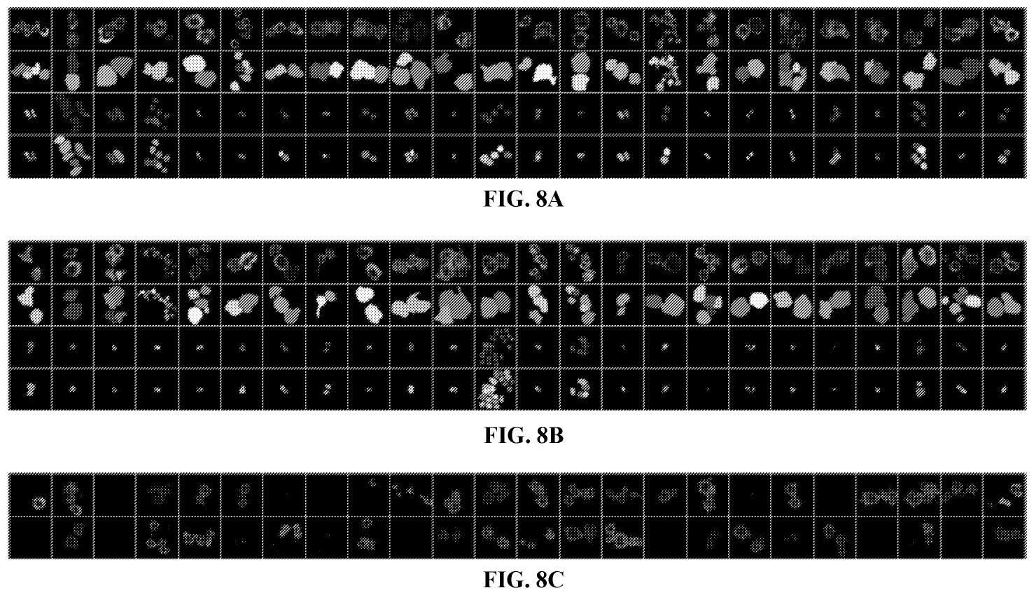

Due to the simplified nature of single-cells, most methods performed well in producing strong artificial single-cells. The results for the image generation are presented in FIGS. 7A-7C. FIGS. 7A-7C show single-cell image generation of CAR-T and Kaggle datasets. In FIG. 7A, the first two rows and last two rows represent the single-cell images and their masks from DAR-T dataset and Kaggle dataset, respectively. FIG. 7B shows the single-cell images and their associated masks that were generated by the described method. The first two rows are the single-cell images generated from the CAR-T dataset and their masks. The last two rows are the single-cell images generated from the Kaggle dataset and their masks. FIG. 7C shows the single-cell images generated by StyleGan2-Diff. In the generation of single-cell images, StyleGan2-Diff had the best performance among selected GAN models. In particular, StyleGAN2-Diff had the best FID/KID scores within the GAN comparisons. As mentioned above, the GAN methods do not produce segmentation results. The proposed method gives competitive, if not better results compared to selected GAN methods and outputs images with a great likeness to the original single-cells. This shows that the controlled environment was successful in the generation of single-cells and preserves the original traits of each natural cell.

### Multi-Cells Image Generation

Multi-cells images are another basic element for cell nuclei microscopical images. The artificial generation of multi-cells is more challenging for GAN models because their numbers are generally much lower than single-cells. This should not affect the model, which has minimal dependence on the number of images to produce high-quality cells. Similar to the previous section, the inventors investigate how the proposed method compares to the GAN models used in the creation of realistic images. Respectively, the inventors perform experiments on CAR-T and Kaggle datasets. The scores are reported in Table 2.

TABLE 2
FID and KID scores for multi-cells

| | |
|---|---|
| Augmentation | Multi-cells |

| Methods | KID¹ | KID² | KID¹ | KID² |
|---|---|---|---|---|
| DCGAN | 215.61 | 404.90 | 0.1911 | 0.2986 |
| BigGAN-SD | 369.78 | 414.81 | 0.3686 | 0.3409 |
| BigGAN-Diff | 171.37 | 126.3 | 0.1300 | 0.1313 |
| StyleGAN2-Diff | 86.74 | 99.04 | 0.0447 | 0.0999 |
| IAAA | 18.33 | 39.93 | 0.0011 | 0.0732 |

¹represents a score using the CAR-T dataset,
²represents a score using the Kaggle dataset

Fréchet Inception Distance. The results show that the proposed method greatly outperforms the existing models across all parameters. The FID score of the proposed method, surpasses the best performing GAN model StyleGAN2-Diff by 68.41 within the CAR-T dataset and 59.11 within the Kaggle dataset.

Kernel Inception Distance. Similar to the FID scores, the data shows the proposed method has a better generation quality for multi-cells. For KID, the best performing GAN model is again StyleGAN2-Diff, which is outperformed by 0.04365 by the proposed method within the CAR-T dataset and 0.0267 within the Kaggle dataset.

The evaluation scores show the difficulty of generating naturalistic multi-cells due to the many variables that result in cell clustering and adhesion. The results to produce multi-cells using the CAR-T dataset and Kaggle dataset are presented in FIGS. 8A-8C. FIGS. 8A-8C show multi-cells image generation on CAR-T and Kaggle datasets. In FIG. 8A, the first two rows and last two rows represent the multi-cells images and their masks from CAR-T dataset and Kaggle dataset, respectively. FIG. 8B shows the multi-cells images and their associated masks that were generated by the described method. The first two rows are the multi-cells images generated from the CAR-T dataset and their masks. The last two rows are the multi-cells images generated from the Kaggle dataset and their masks. FIG. 8C shows the multi-cells images generated by StyleGan2-Diff. In the generation of multi-cells images, StyleGan2-Diff had the best performance among selected GAN models. Similar to the single-cells, samples are provided for observation. As can be seen, the proposed method consistently provides better results compared to GAN for multi-cells. This shows that the controlled environment was again successful in generating new multi-cells while simultaneously preserving the traits found within the original cells.

### Cell Nuclei Image Generation

The proposed method utilizes two sets of images (single-cells and multi-cells), along with recognized noise background, to place them into single frames. The quantity of single-cells and multi-cells are important for creating diverse images. Since the inventors are utilizing small sets of training data, generating artificial data seems more difficult for GANs. The results are shown in Table 3.

TABLE 3

| | |
|---|---|
| Augmentation | Multi-cells |

| Methods | KID¹ | KID² | KID¹ | KID² |
|---|---|---|---|---|
| DCGAN | 343.59 | 435.55 | 0.4563 | 0.3352 |
| BigGAN-SD | 460.66 | 496.38 | 0.5216 | 0.5216 |
| BigGAN-Diff | 115.51 | 297.84 | 0.1313 | 0.3037 |
| StyleGAN2-Diff | 109.30 | 196.92 | 0.0760 | 0.0892 |
| IAAA | 79.57 | 102.99 | 0.0657 | 0.0716 |

¹represents a score using the CAR-T dataset,
²represents a score using the Kaggle dataset

Fréchet Inception Distance. The proposed method was able to consistently outperform the best performing GAN method, StyleGAN2, by 29.73 with the CAR-T dataset and 93.93 with the Kaggle dataset.

Kernel Inception Distance. The results remained consistent with the FID values, with the proposed method outperforming StyleGAN2 by 0.97 using the CAR-T dataset and 0.0176 using the Kaggle dataset.

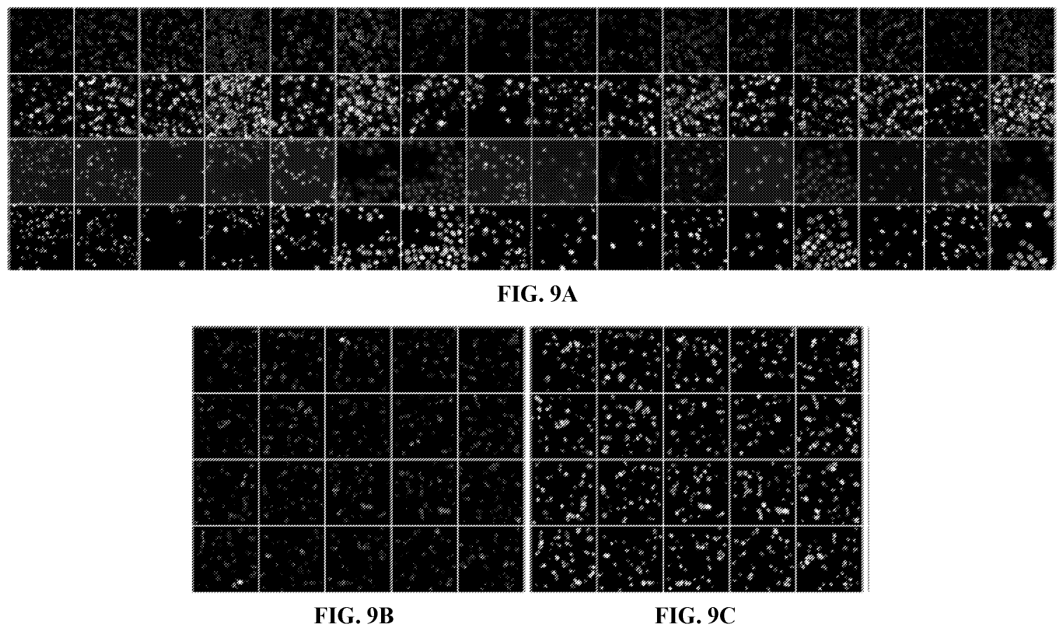

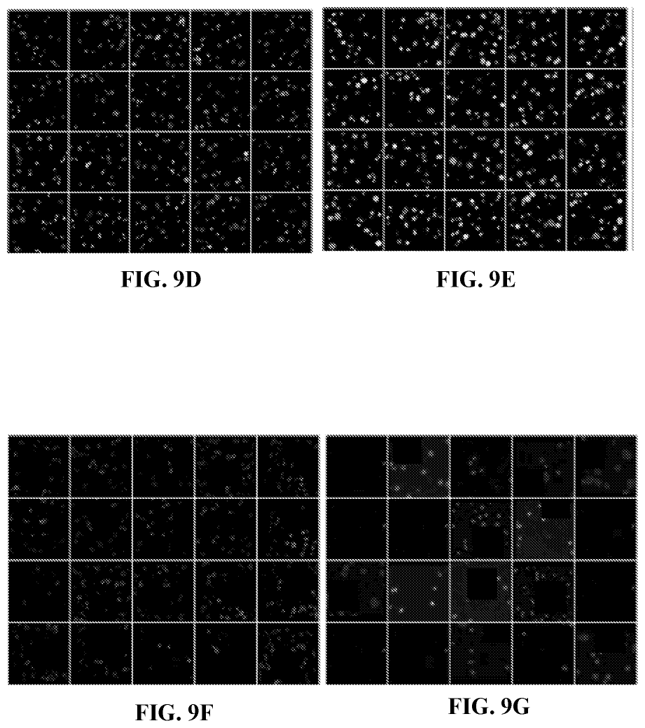

The final results of the creation of complete CAR-T cell images are presented in FIGS. 9A-9G. FIGS. 9A-9G show cell nuclei image generation on CAR-T and Kaggle datasets. In FIG. 9A, the first two rows show original CAR-T dataset, and the last two rows show original Kaggle dataset (real images and masks, respectively). FIGS. 9B and 9C are the CAR-T nuclei images generated by our method and their associated masks. FIGS. 9D and 9E are the Kaggle nuclei images generated by our method and their associated masks. FIGS. 9F and 9G represent CAR-T images and Kaggle images generated by StylGAN2-Diff. The results show the precise segmentation information that the described method provides, as well as demonstrating the clear advantage in the creation of high-quality images over alternative GAN solutions.

### Performance on Real Applications

In Table 4 Part 1, the inventors tested the augmentation algorithm with accuracy (AP score) of 11 state-of-the-art detection algorithms. The values on the left side indicate the AP scores from original algorithms, and the values on the right side indicate the AP scores after applying 100 augmented data to the original training sets. The results show that the inventors could consistently improve the results of these algorithms (30 out of 33).

Complex Datasets: While the dark background was used to create synthetic photo-realistic images, datasets with higher spectral color can still benefit from the method for certain tasks. In Table 4 Part 1, the inventors report the results for bounding box detection for the Neural cells dataset.

TABLE 4
Part 1

| Method | Backbone | CART | Kaggle | Neural |
|---|---|---|---|---|
| multi-stage: | | | | |
| Faster R-CNN | R-101 | 49.6/51.2 | 38.6/44.0 | 48.4/49.7 |
| Cascade R-CNN | R-101 | 49.8/52.5 | 37.5/37.2 | 50.7/50.9 |
| Grid R-CNN | X-101 | 26.1/46.2 | 35.0/40.2 | 38.2/41.0 |
| Libra R-CNN | X-101 | 47.6/48.4 | 43.8/44.5 | 50.0/50.1 |
| RepPoints | R-101 | 43.4/47.5 | 38.8/40.0 | 37.9/36.7 |
| RepPoints | X-101 | 45.3/48.4 | 35.8/38.9 | 42.7/45.9 |
| one-stage: | | | | |
| FreeAnchor | R-101 | 26.6/47.6 | 33.3/33.4 | 48.4/51.2 |
| FSAF | X-101 | 44.1/50.3 | 37.8/40.6 | 48,4/56.0 |
| ATSS | R-101 | 49.9/52.9 | 36.3/37.2 | 46.9/46.0 |
| PAA | R-101 | 47.1/48.3 | 38.5/46.4 | 46.0/49.4 |
| GFL | X-101 | 47.7/53.1 | 37.1/40.4 | 42.1/45.4 |

Conditional GAN: The GAN methods in their pure form cannot be used to improve the bounding box detection because they do not produce the respective labels which are required for comparisons. In Table 4 Part 2, the inventors use the methodology described in Mahmood, F., et al. Deep adversarial training for multi-organ nuclei segmentation in histopathology images. IEEE transactions on medical imaging, 39(11):3257-3267, 2019 for comparing the method with conditional GAN. By applying 100 extra augmentation data to the original training, the inventors could increase the accuracy by 10.79% and 25.67% for CART and Kaggle. The accuracy here is the mean of the Jaccard scores between pairs of generated and original masks for all test points (see Kumar, N., et al. A dataset and a technique for generalized nuclear segmentation for computational pathology. IEEE transactions on medical imaging, 36(7):1550-1560, 2017).

TABLE 4
Part 2

| NSeg-CART | Ours-CART | NSeg-Kaggle | Ours-Kaggle |
|---|---|---|---|
| 32.69 | 43.48 | 52.06 | 77.73 |

Instance Segmentation. For instance segmentation, the results of the mixed CAR-T dataset are at least 0.39% and up to 2.86% higher than results of the real data on AP. It also shows improvement of at least 0.65% and up to 1.18% when compared to the reference CAR-T dataset at IOUs. The details of these experiments are presented in supplementary. The results show that the method could easily improve the accuracy of instance segmentation of cells.

As can be seen from the first set of experiments, the inventors presented Instance Aware Automatic Augmentation for the generation of artificial cell nuclei microscopical images along with their correct instance segmentation masks. An initial set of segmentation objects are used with Greedy AutoAugment to find the best performing policies. The found policies and initial set of segmentation objects are then used to create the final artificial images. The images are compared with state-of-the-art data augmentation methods. The results show that the quality of the proposed method in different stages is on par with the original data and surpasses different GAN models. These observations are confirmed by FID and KID scores. The proposed method is effectively ready to generate artificial cell nuclei microscopical images.

### Experiments and Evaluation of Results

The next set of experiments and evaluation results again utilize the GAN models described in the first experiments and evaluation of results section.

Evaluation metrics. To measure the improvement in bounding box detection, the inventors use variants of average precision (AP) to evaluate and compare how different object detectors perform given artificial data. Average precision computes the average precision value for recall values over 0 to 1. AP₅₀ and AP₇₅ are metrics used to evaluate the intersection over a union of objects (IoU). A perfect prediction yields an IoU value of 1, while a completely wrong detection yields a value of 0. A degree of overlap gives a value between the two. A decision can be made on how much overlap can potentially be considered a correct prediction. Hence, AP₅₀ and AP₇₅ gives the average precision with IoU thresholds of 0.5 and 0.75, respectively. The APₛ represents how well the model performs with small objects. Since APs is used to evaluate the identification of small objects, it is specifically important for nuclei cell detection.

Experiment setup. All of the experiments were conducted on K80 NVIDIA graphic cards. As for the embedded deep neural networks for our method, the inventors used PyTorch. For Greedy AutoAugment and Wasserstein variation the inventors used the official implementations. For the experiments, all of the models were compared with their baseline released codes from the authors. The inventors did not alter the suggested configuration from the official papers. To reduce computations, the inventors search the search space of augmentation policies within the maximum number of 20000 policies, in which the top 1000 performing policies are used. All of the GAN models were trained for 150000 epochs across all the experiments.

The inventors use three cell nuclei datasets containing microscopical images obtained from two different biological fields. The CAR-T cell dataset consists of 156 images at a resolution of 1024×1024, divided into train, test, and validation sets with 93, 31, and 32 images. The second dataset is from the Kaggle 2018 Data Science Bowl, which contains around 589 images that were acquired under a variety of conditions and vary in the cell type, magnification, and imaging modality (brightfield vs, fluorescence). A subset of 193 images, which share consistent attributes, and is divided into train, test, and validation sets with 117;38; and 38 images. To test bright color images the inventors use the Neural dataset consisting of 644 images at a resolution of 640×512, also divided into train, test, and validation sets with 386, 129, and 129 images.

### Single-Cell Image Generation

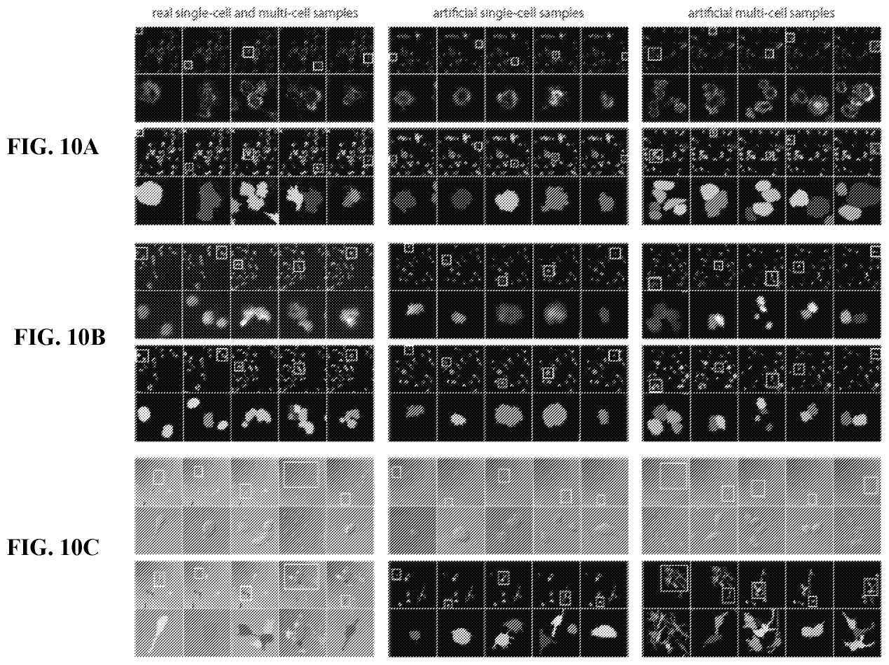

Due to the simplified nature of single-cells, most methods perform well in producing strong artificial single-cells. The results for the image generation are presented in FIGS. 10A-10C. FIGS. 10A-10C show cell nuclei image generation on CAR-T (FIG. 10A). Kaggle (FIG. 10B), and Neural datasets (FIG. 10C). The first column represents the reference (real) images, and the second and third columns are images generated by the described method. The images are accompanied by their associated masks. For reference, a zoomed in image of five regions of the images for single cells in the second column and multi-cells in the third column are shown. The first column zooms into five regions that include both single-cell images and multi-cell nuclei images. The second column of FIG. 10A (artificial single-cell samples) shows the single-cell images and their associated masks that were generated by our method for the CAR-T dataset. The second column of FIG. 10B shows the single-cell images and their associated masks that were generated by the proposed method for the Kaggle dataset. Respectively, the first three images of the first column (real single-cell and multi-cell samples) show the original single-cell images with their labels. In all the images, the first row shows the original images, and the second row is for zoomed in regions. From the images, the proposed method produces outputs with a great likeness to the original single-cells. This shows that the controlled environment was successful in the generation of single-cells and preserves the original traits of the natural cells found in the raw data.

### Multi-Cell Image Generation

The results to produce multi-cells using the CAR-T dataset and Kaggle dataset are also shown in FIGS. 10A-10C. Similar to the single-cells, samples are provided for observation. The third column of FIG. 10A (artificial multi-cell samples) shows the multi-cell images and their associated masks that were generated by the proposed method for CAR-T dataset. The third column of FIG. 10B shows the multi-cell images and their associated masks that were generated by the proposed method for Kaggle dataset. Respectively, the last two images of the first column (real single-cell and multi-cell samples) show the original multi-cell images with their labels. The results show that the controlled environment was again successful in generating new multi-cells while simultaneously preserving the traits found within the original cells.

### Performance of Real-World Bounding Box Detection

In this section, the inventors show the performance improvements of bounding box detection when the proposed augmentation method is applied. For training, the inventors follow the standard practice for bounding box detection algorithms and train for 12 epochs. The experiments involve both multi-stage and one-stage bounding box detection algorithms. The inventors use the following state-of-the-art studies for bounding box detection. Faster R-CNN w/FPN²¹, Cascade R-CNN²², Grid R-CNN²³, Libra R-CNN²⁴, RepPoints²⁵, FreeAnchor²⁶, FSAF²⁷, ATSS²⁸, PAA²⁹, GFL²⁰. These networks are implemented on MMDetection software, based on ResNet-101 (R-101) and ResNeXt-101 (X-101) backbones.

FIG. 32 shows a table of the Ap, AP50, AP75, and APS scores of bounding box (bbox) detection on CAR-T. Kaggle, and Neural datasets. The values for the datasets represent the original complete cell nuclei images and the values for AUG+Datasets represent the original complete cell nuclei images with the addition of augmented images.

CAR-T Dataset. The inventors first investigate the effectiveness of the method on the CAR-T dataset (the left-most numbers for each column in FIG. 32). According to the results, the augmented data consistently improves the results. For the AP scores, 11 out of 11 methods are improved. The AP₅₀ shows that 10 out of 11 methods show significant improvements, the AP₇₅ scores show that 11 out of 11 methods improve, and the APₛ indicates that 9 out of 11 methods are improved. The improvement of the methods is consistent, with an average 5.94% increase in overall AP evaluation across all the experiments.

Kaggle Dataset. The inventors investigated the effectiveness of the proposed augmentation method on the Kaggle dataset (the middle numbers in FIG. 32). According to the results, the inventors additionally observe that the augmented data consistently improves the results when using the Kaggle dataset. For the AP, 10 out of the 11 methods show improvements. The AP₅₀ shows that 6 out of the 11 methods are improved, the AP₇₅ shows that 10 out of the 11 methods are improved, and the APₛ also shows a performance increase across 10 out of the 11 methods. Overall, the improvements to the 11 methods are consistent. The average performance gain is 1.77% across the experiments.

### Experiments for Bright Color Microscopical Images

To test the proposed method for images in the high spectrum color, the inventors use the Neural dataset. In the following, the average scores for FID and KID scores for this dataset are reported.

Fréchet Inception Distance. The FID scores for DCGAN, BigGAN-SD, BigGAN-Diff, StyleGAN2-Diff, and Sem-Aware are in order, 224.33278.4576.20.37.73, and 52.49. The proposed method was able to create natural images and produce the second-best FID score when creating artificial images in 128×128 resolution.

Kernel Inception Distance. The results remained consistent with the FID values. The KID scores for DCGAN, BigGAN-SD, BigGAN-Diff, StyleGAN2-Diff, and Sem-Aware are in order, 0.1803, 0.2361, 0.0619, 0.0147, and 0.0310. The proposed method was able to create natural images and produce the second-best KID score when creating artificial images in 128×128 resolutions.

As mentioned above, the final results of the creation of complete Neural cell images are presented in FIG. 10C. The second column of FIG. 10C shows the single-cell images and their associated masks that were generated by the proposed method for the Neural dataset. Similar to the CAR-T and Kaggle results, the FIG. 10C represents zoomed in regions for single-cells and multi-cells along with samples from the original dataset.

The inventors investigated the effectiveness of the proposed augmentation method on the Neural dataset (also shown in FIG. 32). According to the results, the inventors observe that the augmented data consistently improves the results. The AP evaluation shows improvements for 10 out of the 11 methods. The AP₅₀ shows that 7 out of the 11 methods are improved, the AP₇₅ shows that 10 out of the 11 methods are improved, and finally the APₛ shows that 10 out of the 11 methods are improved. The average performance increase of AP evaluation is 2.15% across the experiments. Although, this dataset contains images with brighter colors, the performance gain is consistent with the gains observed within the CAR-T and Kaggle datasets.

The inventors presented Instance Aware Automatic Augmentation for the generation of artificial cell nuclei microscopical images along with their correct instance segmentation labels. An initial set of segmentation objects are used with Greedy AutoAugment to find the best performing policies. The found policies and initial set of segmentation objects are then used to create the final artificial images. The images are compared with state-of-the-art data augmentation methods. The results show that the quality of the proposed method in different stages is on par with the original data and surpasses different GAN models. These observations are confirmed by FID and KID scores. The experiments demonstrate that the proposed augmentation technique consistently improves the detection of cells which is confirmed by variants of AP scores. The proposed method is effectively ready to generate artificial cell nuclei microscopical images. In the future, this method can help to better train microscopical images with artificial neural networks.

### Additional Experiments

For the additional experiments, the inventors use data generated by the proposed method to improve cell segmentation accuracy and the robustness of model training results. All of our experiments in supplementary are conducted on RTX Titan NVIDIA graphic cards. As for the embedded deep neural networks for our method, the inventors used Pytorch. For WAE, the inventors used the implementation in and for the KG Instance Segmentation the inventors used the implementation by the author.

### Data Preparation

Original Datasets The inventors used three cell nuclei datasets containing microscopical images obtained from two different biological fields. The CAR-T cell dataset consists of 156 images at a resolution of 1024×1024, divided into train, test, and validation sets with 93;31; and 32 images. The second dataset is from the Kaggle 2018 Data Science Bowl, which contains around 589 images that were acquired under a variety of conditions and vary in the cell type, magnification, and imaging modality (brightfield vs, fluorescence). A subset of 193 images, which share consistent attributes, and is divided into train, test, and validation sets with 117;38; and 38 images. To test bright color images the inventors use the Neural dataset consisting of 644 images at a resolution of 640×512, also divided into train, test, and validation sets with 386;129; and 129 images.

Mixed Datasets The inventors mixed the images generated by the proposed method with the original images. The mixture is only for the training sets and not validation and test sets. After combining, the training set for CAR-T cell dataset contains 200 images which is a combination of 93 original images and 107 generated images. The training set for Kaggle 2018 Data Science Bowl dataset contains 200 images which is a combination of 117 original images and 83 generated images. The training set of the Neural dataset contains 800 images which is a combination of 386 original images and 414 generated images.

Evaluation In order to verify the effect of our method on real data, the training results of the two datasets (Original Datasets and Mixed Datasets) are both evaluated on the real test sets for all three datasets.

As shown in Table 6 and Table 7, for the BBox detection performances, the training results of the mixed dataset is at least 0.15% and at most 7.63% better than the results of the real dataset on the AP. For instance segmentation, the results of the mixed dataset is at least 0.49% and up to 16.85% higher than results of the real data on AP. It also shows improvement of at least 0.04% and up to 1.87% when compared to the reference datasets at IOUs.

TABLE 6

| BBox | Mixed Car-T | Original Car-T |
|---|---|---|
| Evaluation: | Dataset | Dataset |
| AP@0.5 CAR-T | 77.41 | 73.56 |
| AP@0.7 CAR-T | 61.66 | 61.68 |
| AP@0.5 Kaggle | 44.70 | 44.08 |
| AP@0.7 Kaggle | 33.48 | 33.33 |
| AP@0.5 Neural | 62.18 | 54.55 |
| AP@0.7 Neural | 38.12 | 31.49 |

TABLE 7

| Segmentation | Mixed Car-T | Original Car-T |
|---|---|---|
| Evaluation: | Dataset | Dataset |
| AP@0.5 CAR-T | 76.78 | 73.99 |
| IOU@0.5 CAR-T | 81.07 | 80.49 |
| AP@0.7 CAR-T | 61.22 | 60.63 |
| IOU@0.7 CAR-T | 84.73 | 83.92 |
| AP@0.5 Kaggle | 70.71 | 62.44 |
| IOU@0.5 Kaggle | 80.30 | 79.72 |
| AP@0.7 Kaggle | 51.25 | 50.76 |
| IOU@0.7 Kaggle | 84.79 | 84.56 |
| AP@0.5 Neural | 55.65 | 38.80 |
| IOU@0.5 Neural | 74.49 | 72.62 |
| AP@0.7 Neural | 32.62 | 17.82 |
| IOU@0.7 Neural | 81.27 | 81.23 |

The results show that the method could easily improve the accuracy of object detection and instance segmentation of cells. The reason is that augmentation generates a lot of new data that benefits the generalization of the training process, which reduces overfitting and improves the robustness of the model. The experiments show that there should be a balance between real and artificial samples. The inventors observed that if the number of artificial samples is around the same number of real training data, it can generally increase the accuracy. For higher orders of artificial data, if the real data can provide high accuracy, overshadowing the data with artificial samples can have negative results. However, if the original data cannot provide high accuracy, higher artificial samples generally lead to better results.

The following Figures show additional generated image samples

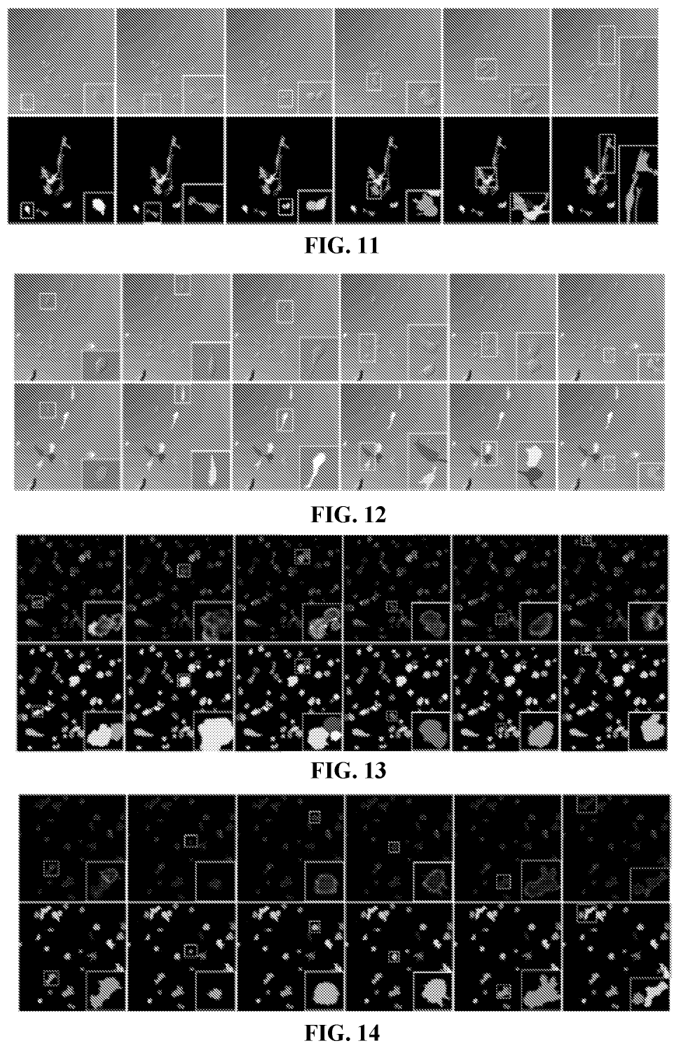

FIG. 11 shows sample of an artificially generated Neural dataset (first row) with its respective instance segmentation (second row). In six different locations, the zoom-in functionality is used to provide better details of the generated cells and their respective masks.

FIG. 12 shows a real sample from the Neural dataset (first row) with its respective instance segmentation (second row). In six different locations, the zoom-in functionality is used to provide better details of the real cells and their respective masks.

FIG. 13 shows a sample of an artificially generated CAR-T dataset (first row) with its respective instance segmentation (second row). In six different locations, the zoom-in functionality is used to provide better details of the generated cells and their respective masks.

FIG. 14 shows a real sample from the CAR-T dataset (first row) with its respective instance segmentation (second row). In six different locations, the zoom-in functionality is used to provide better details of the real cells and their respective masks.

FIG. 15 shows a sample of an artificially generated Kaggle dataset (first row) with its respective instance segmentation (second row). In six different locations, the zoom-in functionality is used to provide better details of the generated cells and their respective masks.

FIG. 16 shows a real sample from the Kaggle dataset (first row) with its respective instance segmentation (second row). In six different locations, the zoom-in functionality is used to provide better details of the real cells and their respective masks.

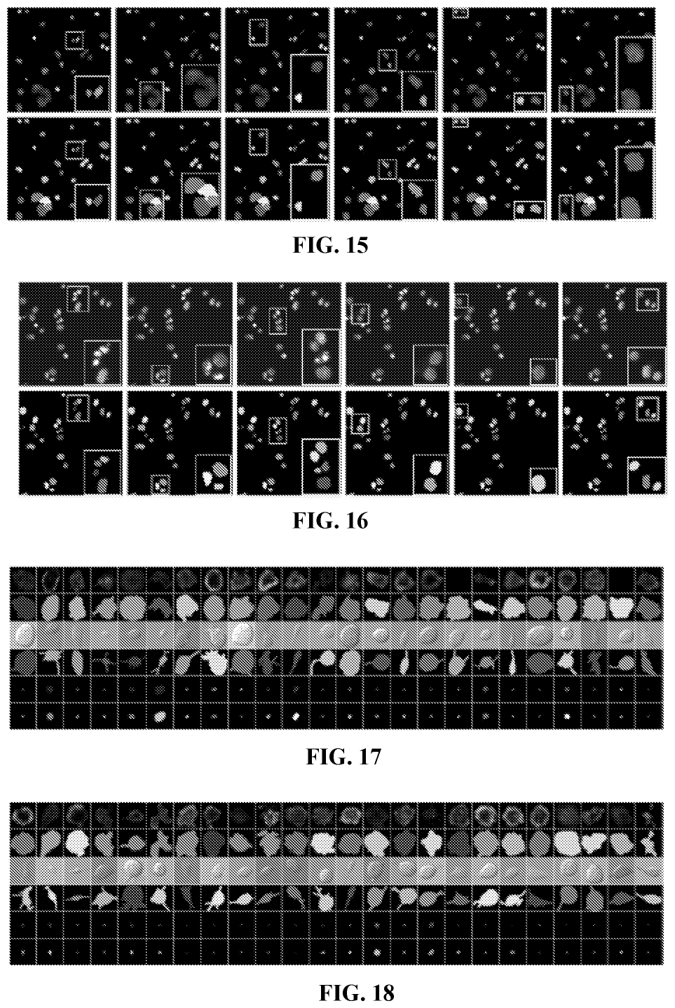

FIG. 17 shows single-cell real images on CAR-T, Neural, and Kaggle datasets; The first two rows represent the single-cell images and their masks from CAR-T dataset. The third and fourth rows represent the single-cell images and their masks from Neural dataset. The fifth and sixth rows represent the single-cell images and their masks from Kaggle dataset.

FIG. 18 shows single-cell image generation on CAR-T, Neural, and Kaggle datasets; The first two rows represent the single-cell images and their masks from CAR-T dataset. The third and fourth rows represent the single-cell images and their masks from Neural dataset. The fifth and sixth rows represent the single-cell images and their masks from Kaggle dataset.

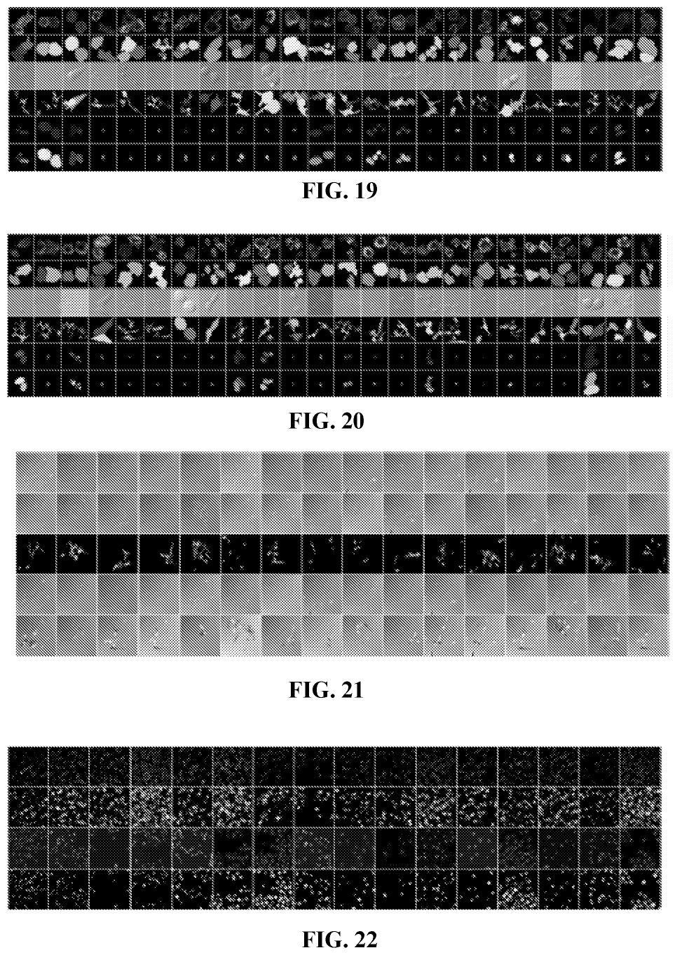

FIG. 19 shows multi-cell real images on CAR-T, Neural and Kaggle datasets; The first two rows represent the multi-cell images and their masks from CAR-T dataset. The third and fourth rows represent the multi-cell images and their masks from Neural dataset. The fifth and sixth rows represent the multi-cell images and their masks from Kaggle dataset.

FIG. 20 shows multi-cell image generation on CAR-T, Neural and Kaggle datasets; The first two rows represent the multi-cell images and their masks from CAR-T dataset. The third and fourth rows represent the multi-cell images and their masks from Neural dataset. The fifth and sixth rows represent the multi-cell images and their masks from Kaggle dataset.

FIG. 21 shows a comparison between complete image generation of Neural dataset; The first row represents 16 images from StyleGAN2-Diff. The second and third rows represent images that are generated from the proposed method. The fourth and fifth rows represent real images and their respective masks.

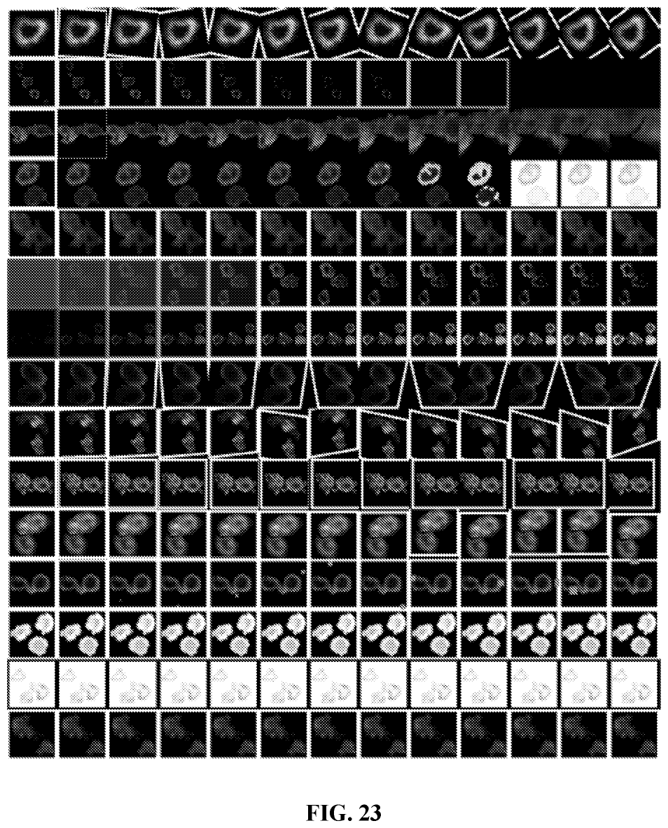

FIG. 22 shows images of the original CAR-T dataset and the original Kaggle dataset. The first two rows show original CAR-T dataset, and the last two rows show original Kaggle dataset.

FIG. 23 shows a sample using different forms of augmentation techniques on the cells. Each row represents a new augmentation technique applied on a multi-cell within the CAR-T dataset. The augmentations used in the order of rows are: ‘Rotate’, ‘Posterize’, ‘CropBilinear’, ‘Solarize’, ‘Color’, ‘Contrast’, ‘Brightness’, ‘ShearX’, ‘ShearY’, ‘TranslateX’, ‘TranslateY’, ‘Cutout’, ‘Equalize’, ‘Invert’, ‘AutoContrast’.

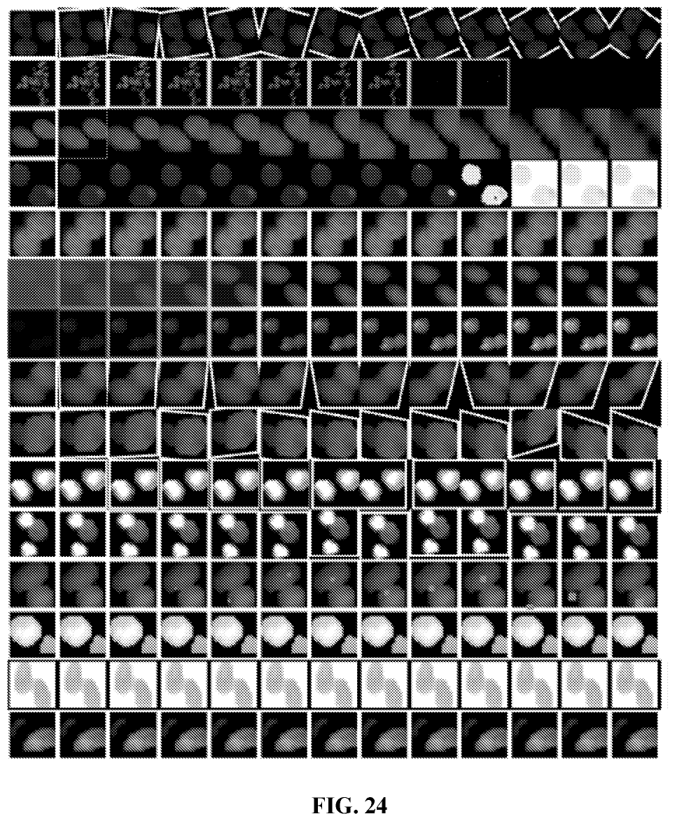

FIG. 24 shows a sample using different forms of augmentation techniques on the cells. Each row represents a new augmentation technique applied on a multi-cell within the Kaggle dataset. The augmentations used in the order of rows are: ‘Rotate’, ‘Posterize’, ‘CropBilinear’, ‘Solarize’, ‘Color’, ‘Contrast’, ‘Brightness’, ‘ShearX’, ‘ShearY’, ‘TranslateX’, ‘TranslateY’, ‘Cutout’, ‘Equalize’, ‘Invert’, ‘AutoContrast’.

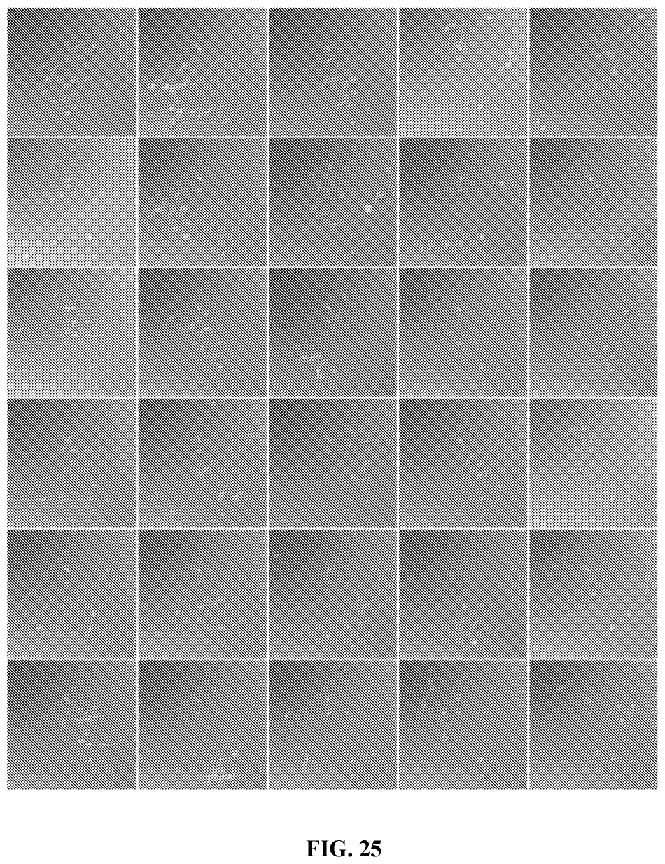

FIG. 25 shows a sample of the final images created from the proposed method (128×128 for each sample) using the Neural dataset.

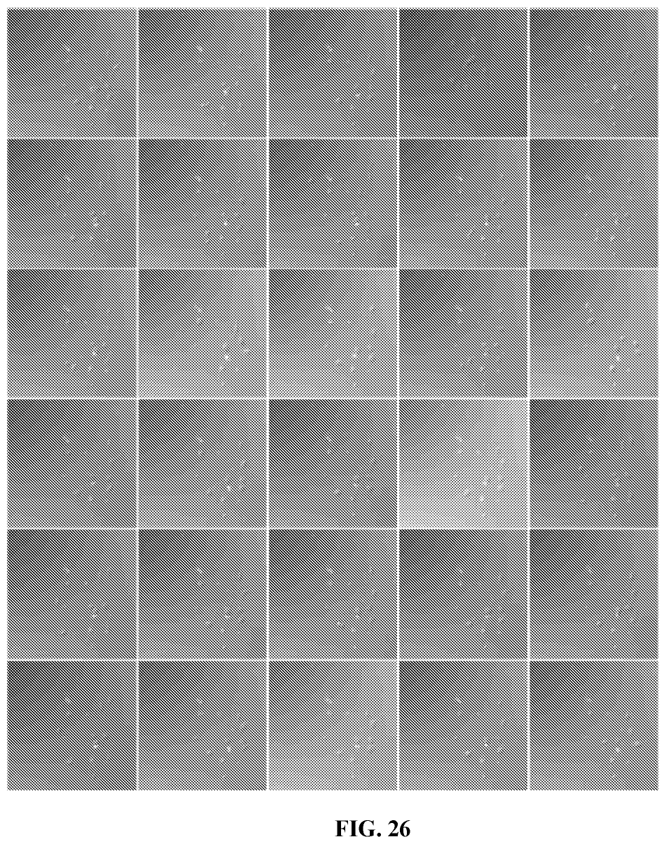

FIG. 26 shows a sample of the final images created from the real images (128×128 for each sample) using the Neural dataset.

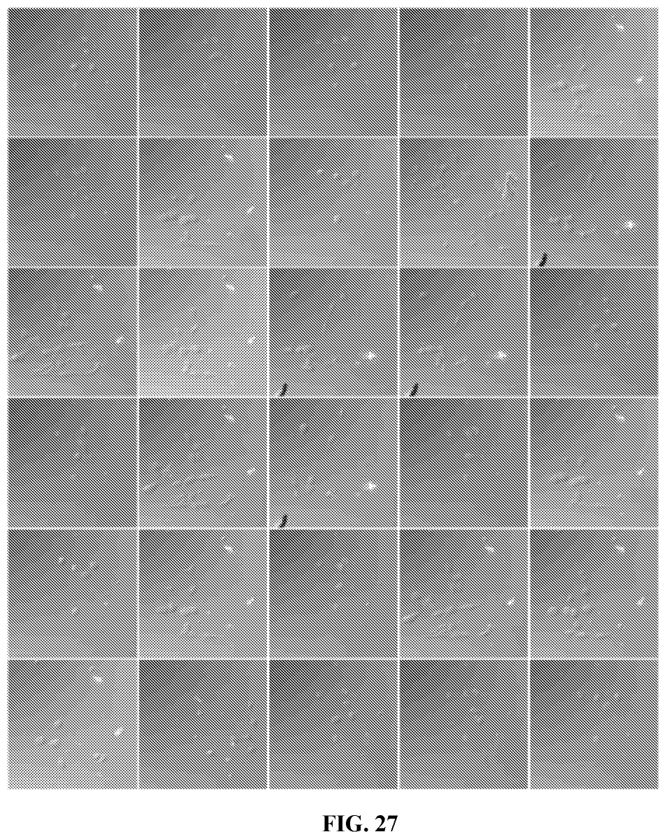

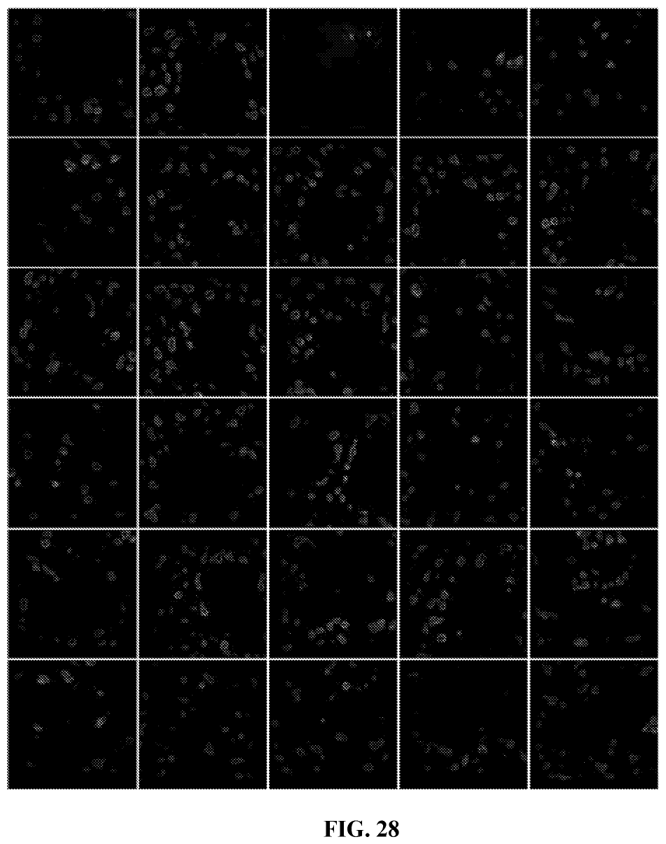

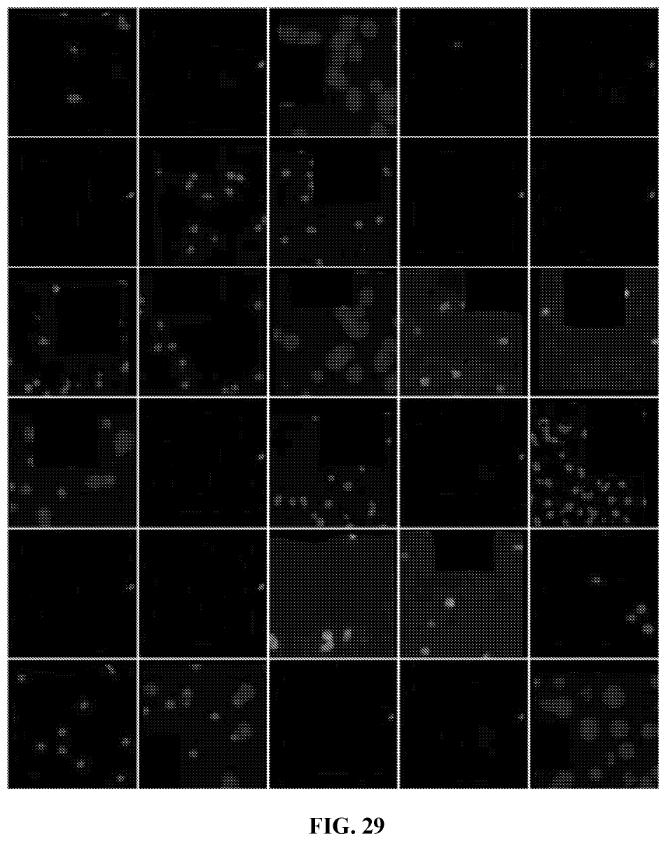

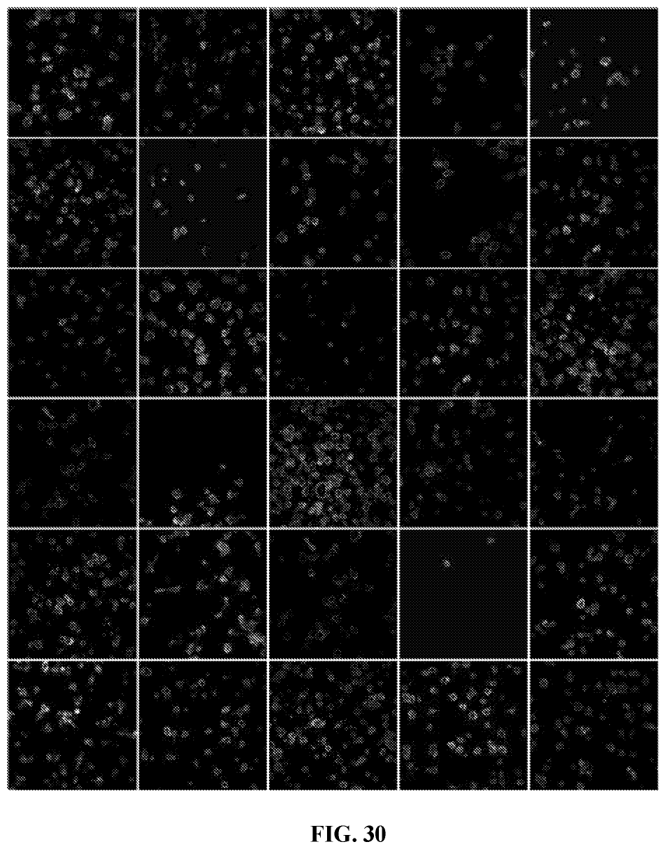

FIG. 27 shows a sample of the final images created from the StyleGAN2-Diff method (128×128 for each sample) using the Neural dataset.

FIG. 28 shows a sample of the final images created from the StyleGAN2-Diff method (128×128 for each sample) using the CAR-T dataset.

FIG. 29 shows a sample of the final images created from the StyleGAN2-Diff method (128×128 for each sample) using the Kaggle dataset.

FIG. 30 shows a sample of the final images created from the real images (128×128 for each sample) using the CAR-T dataset.

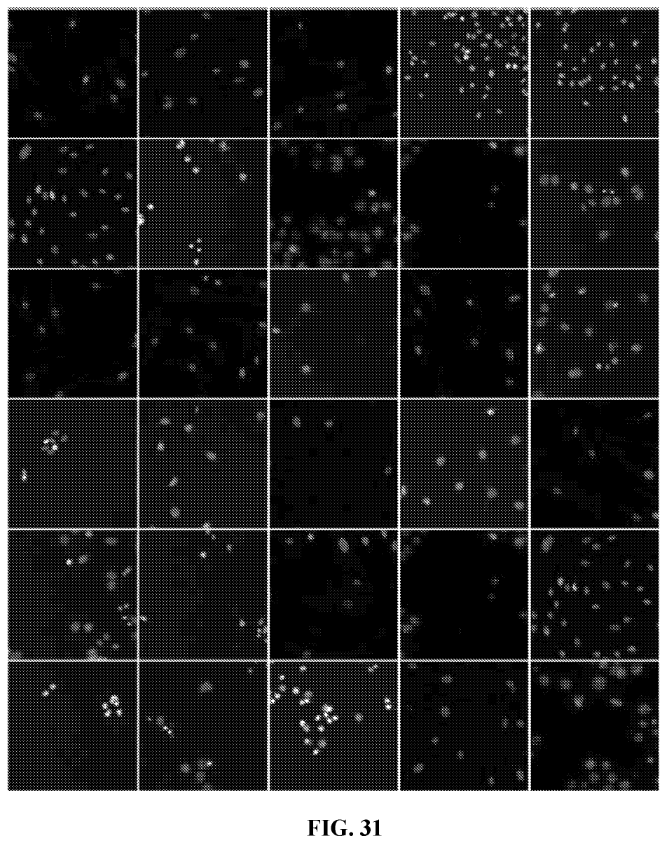

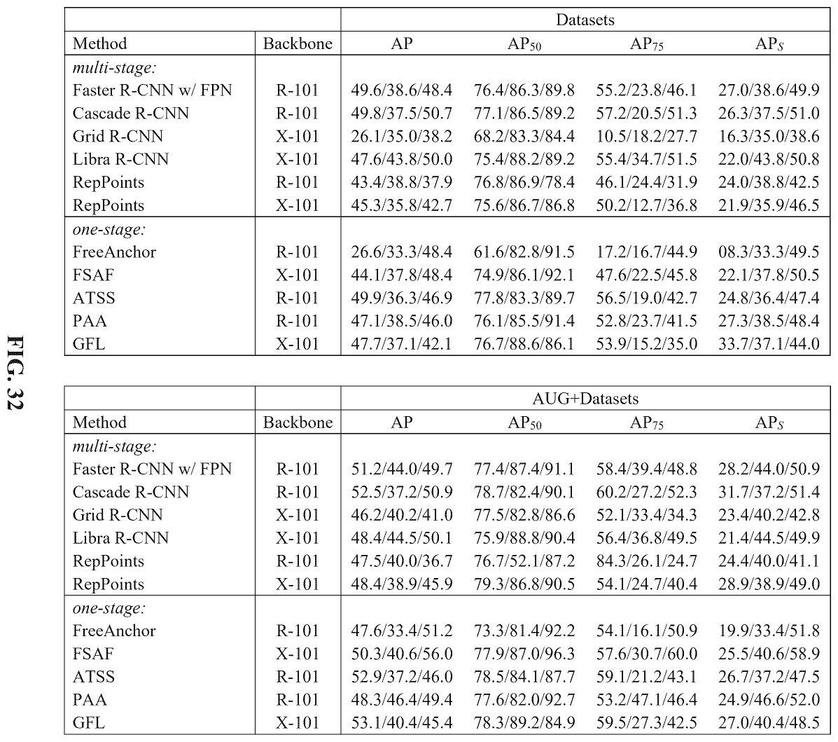

FIG. 31 shows a sample of the final images created from the real images (128×128 for each sample) using the Kaggle dataset.

The following provides some example methods of generating artificial images for medical evaluation of eukaryotic cells. These methods can be implemented as instructions stored on and executed by a computing system.
Clause 1. A method of generating artificial images for medical evaluation of eukaryotic cells, comprising: extracting each instance of single-cells in an image of eukaryotic cells; extracting each instance of multi-cells in the image of eukaryotic cells; generating a background image from the image of eukaryotic cells; selecting a set of cells from the extracted single-cells and the extracted multi-cells; applying at least one augmentation technique to each cell in the set of cells to generate augmented cells; and generating an artificial image of eukaryotic cells using the augmented cells and the background image.
Clause 2. The method of clause 1, wherein generating the background image from the image of eukaryotic cells comprises: generating a bounding box around at least one instance of a eukaryotic cell in the image of eukaryotic cells, wherein pixels of the image of eukaryotic cells inside the bounding box are inside pixels; and replacing values of the inside pixels with values corresponding to certain pixels found outside of the bounding box that are similar in values as bordering pixels of the bounding box to remove the at least one instance of the eukaryotic cell in the image of eukaryotic cells, wherein the certain pixels found outside of the bounding box are outside pixels.
Clause 3. The method of clause 2, wherein generating the background image from the image of eukaryotic cells further comprises: performing the generating of the bounding box around the at least one instance of the eukaryotic cell in the image of eukaryotic cells and the replacing of the values of the inside pixels until all instances of eukaryotic cells are removed.
Clause 4. The method of clause 2 or 3, wherein replacing the values of the inside pixels with values corresponding to certain pixels found outside of the bounding box that are similar in values as bordering pixels of the bounding box comprises: for each inside pixel: selecting a predetermined number of outside pixels, comparing each of the predetermined number of outside pixels to pixels at corners of the bounding box to identify an outside pixel of the predetermined number of outside pixels that is most similar to the pixels at the corners of the bounding box, and replacing that inside pixel with the identified outside pixel.
Clause 5. The method of clause 4, wherein the predetermined number of outside pixels are selected randomly.
Clause 6. The method of clause 4, wherein comparing each of the predetermined number of outside pixels to pixels at corners of the bounding box to identify the outside pixel of the predetermined number of outside pixels that is most similar to the pixels at the corners of the bounding box comprises evaluating similarity using a mean Euclidean distance.
Clause 7. The method of any of clauses 2-6, wherein generating the background image from the image of eukaryotic cells further comprises: creating a masking image, wherein the masking image is an image with a black-colored background having a smaller, white area in a middle, wherein the masking image is a same size as the bounding box; applying a Gaussian filter to the masking image to generate a filtered masking image; inserting the filtered masking image in a same position as the bounding box; and smoothing an area of the image of eukaryotic cells where the at least one instance of eukaryotic cells was removed using the filtered masking image.
Clause 8. The method of any preceding clause, wherein generating the artificial image of eukaryotic cells using the augmented cells and the background image comprises: placing a selection of the augmented cells on the background image.
Clause 9. The method of clause 8, wherein the selection of the augmented cells mimics a distribution of the eukaryotic cells in the image of eukaryotic cells.
Clause 10. The method of clause 8, wherein the selected augmented cells are placed randomly on the background image.
Clause 11. The method of clause 8, wherein placing the selection of the augmented cells on the background image comprises: generating a bounding box around at least one cell from the selection of the augmented cells; comparing pixels from four corners of the bounding box to pixels in the background image to determine a target location, wherein the target location is an area of the background image where the pixels in the background image have a highest degree of similarity to the pixels in the four corners of the bounding box; placing the at least one of the selection of the augmented single-cells and the augmented multi-cells in the target location; creating a cell masking image, wherein the cell masking image includes a black color background and a white area in the middle, wherein the white area is substantially the same shape as the at least one cell from the selection of the augmented single-cells and the augmented multi-cells; and applying a Gaussian filter to smooth a transition between texture of the background image and texture of the at least one cell from the selection of the augmented single-cells and the augmented multi-cells.
Clause 12. The method of clause 11, wherein comparing pixels from four corners of the bounding box to pixels in the background image to determine the target location comprises using a mean Euclidean distance for determining similarity.
Clause 13. The method of clause 11 or 12, wherein the bounding box further comprises a height.
Clause 14. The method of any preceding clause, wherein the at least one augmentation technique applied to each cell corresponds to a particular augmentation policy of a pre-determined selection of a set of augmentation techniques.
Clause 15. The method of clause 14, wherein augmentation techniques of the pre-determined selection of the set of augmentation techniques are selected from FlipLR, FlipUD, AutoContrast, Equalize, Rotate, Posterize, Contrast, Brightness, Sharpness, Smooth, and Resize.
Clause 16. A method of generating artificial images for medical evaluation of eukaryotic cells, comprising: extracting each instance of single-cells in an image of eukaryotic cells; extracting each instance of multi-cells in the image of eukaryotic cells; selecting a set of cells from the extracted single-cells and the extracted multi-cells; applying at least one augmentation technique to each cell in the set of cells to generate augmented cells; and generating an artificial image of eukaryotic cells using the augmented cells.
Clause 17. The method of clause 16, wherein extracting each instance of single-cells includes identifying each instance of single-cells in the image of eukaryotic cells, labelling each instance of single-cells as a single-cell, and storing each instance of single-cells in a single-cell resource.
Clause 18. The method of clause 16, wherein extracting each instance of multi-cells includes identifying each instance of multi-cell groupings in the image of eukaryotic cells, labelling each instance of multi-cells as a multi-cell, and storing each instance of multi-cells in a multi-cell resource.
Clause 19. The method of clause 16, wherein selecting the set of cells from the extracted single-cells and the extracted multi-cells comprises randomly selecting the cells.
Clause 20. The method of clause 16, wherein selecting the set of cells from the extracted single-cells and the extracted multi-cells comprises mimicking a distribution of the eukaryotic cells in the original image of eukaryotic cells.
Clause 21. The method of clause 16, wherein the at least one augmentation technique applied to each cell corresponds to a particular augmentation policy of a pre-determined selection of a set of augmentation techniques.
Clause 22. The method of clause 21, further comprising identifying the particular augmentation policy used for the at least one augmentation technique applied to each cell, wherein identifying the particular augmentation policy used for the at least one augmentation technique applied to each cell comprises: applying potential policies of combinations of augmentation techniques to a cell; scoring results of the application of the potential policies; ranking the scored results; and selecting a highest ranking one or more potential policies as the particular augmentation policy.
Clause 23. The method of clause 21, wherein the augmentation techniques of the pre-determined selection of the set of augmentation techniques are selected from FlipLR, FlipUD, AutoContrast, Equalize, Rotate, Posterize, Contrast, Brightness, Sharpness, Smooth, and Resize.
Clause 24. The method of clause 16, wherein generating the artificial image of eukaryotic cells using the augmented cells comprises placing a selection of the augmented cells on a background image.
Clause 25. The method of clause 24, wherein the selected augmented cells are placed randomly on the background image.
Clause 26. The method of clause 24, further comprising generating the background image from the image of eukaryotic cells.
Clause 27. The method of clause 26, wherein generating the background image from the image of eukaryotic cells comprises generating a bounding box around at least one instance of a eukaryotic cell in the image of eukaryotic cells, wherein pixels of the image of eukaryotic cells inside the bounding box are inside pixels; and replacing values of the inside pixels with values corresponding to certain pixels found outside of the bounding box that are similar in values as bordering pixels of the bounding box to remove the at least one instance of the eukaryotic cell in the image of eukaryotic cells, wherein the certain pixels found outside of the bounding box are outside pixels.
Clause 28. The method of clause 27, wherein creating the background image further comprises: creating a masking image, wherein the masking image is an image with a black-colored background having a smaller, white area in the middle, wherein the masking image is the same size as the bounding box; applying a Gaussian filter to the masking image to generate a filtered masking image; inserting the filtered masking image in the same position as the bounding box; and smoothing an area of the image of eukaryotic cells where the at least one instance of eukaryotic cells was removed.
Clause 29. The method of clause 26, further comprising placing at least one cell from the selection of the augmented single-cells and the augmented multi-cells onto the background image via the method comprising: generating a bounding box around the at least one cell from the selection of the augmented single-cells and the augmented multi-cells; comparing pixels from four corners of the bounding box to pixels in the background image to determine a target location, wherein the target location is an area of the background image where the pixels in the background image have the highest degree of similarity to the pixels in the four corners of the bounding box; placing the at least one of the selection of the augmented single-cells and the augmented multi-cells in the target location; creating a cell masking image, wherein the cell masking image includes a black color background and a white area in the middle, wherein the white area is substantially the same shape as the at least one cell from the selection of the augmented single-cells and the augmented multi-cells; and applying a Gaussian filter to smooth the transition between texture of the background image and texture of the at least one cell from the selection of the augmented single-cells and the augmented multi-cells.
Clause 30. The method of clause 29, wherein the bounding box further comprises a height.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

1. A method of generating artificial images for medical evaluation of eukaryotic cells, comprising:
extracting each instance of single-cells in an image of eukaryotic cells;
extracting each instance of multi-cells in the image of eukaryotic cells;
generating a background image from the image of eukaryotic cells;
selecting a set of cells from the extracted single-cells and the extracted multi-cells;
applying at least one augmentation technique to each cell in the set of cells to generate augmented cells; and
generating an artificial image of eukaryotic cells using the augmented cells and the background image.

2. The method of claim 1, wherein generating the background image from the image of eukaryotic cells comprises:
generating a bounding box around at least one instance of a eukaryotic cell in the image of eukaryotic cells, wherein pixels of the image of eukaryotic cells inside the bounding box are inside pixels; and
replacing values of the inside pixels with values corresponding to certain pixels found outside of the bounding box that are similar in values as bordering pixels of the bounding box to remove the at least one instance of the eukaryotic cell in the image of eukaryotic cells, wherein the certain pixels found outside of the bounding box are outside pixels.

3. The method of claim 2, wherein generating the background image from the image of eukaryotic cells further comprises:
performing the generating of the bounding box around the at least one instance of the eukaryotic cell in the image of eukaryotic cells and the replacing of the values of the inside pixels until all instances of eukaryotic cells are removed.

4. The method of claim 2, wherein replacing the values of the inside pixels with values corresponding to certain pixels found outside of the bounding box that are similar in values as bordering pixels of the bounding box comprises:
for each inside pixel;
selecting a predetermined number of outside pixels,
comparing each of the predetermined number of outside pixels to pixels at corners of the bounding box to identify an outside pixel of the predetermined number of outside pixels that is most similar to the pixels at the corners of the bounding box, and
replacing that inside pixel with the identified outside pixel.

5. The method of claim 4, wherein the predetermined number of outside pixels are selected randomly.

6. The method of claim 4, wherein comparing each of the predetermined number of outside pixels to pixels at corners of the bounding box to identify the outside pixel of the predetermined number of outside pixels that is most similar to the pixels at the corners of the bounding box comprises evaluating similarity using a mean Euclidean distance.

7. The method of claim 2, wherein generating the background image from the image of eukaryotic cells further comprises:
creating a masking image, wherein the masking image is an image with a black-colored background having a smaller, white area in a middle, wherein the masking image is a same size as the bounding box;
applying a Gaussian filter to the masking image to generate a filtered masking image;
inserting the filtered masking image in a same position as the bounding box; and
smoothing an area of the image of eukaryotic cells where the at least one instance of eukaryotic cells was removed using the filtered masking image.

8. The method of claim 1, wherein generating the artificial image of eukaryotic cells using the augmented cells and the background image comprises:
placing a selection of the augmented cells on the background image.

9. The method of claim 8, wherein the selection of the augmented cells mimics a distribution of the eukaryotic cells in the image of eukaryotic cells.

10. The method of claim 8, wherein the selected augmented cells are placed randomly on the background image.

11. The method of claim 8, wherein placing the selection of the augmented cells on the background image comprises:
generating a bounding box around at least one cell from the selection of the augmented cells;
comparing pixels from four corners of the bounding box to pixels in the background image to determine a target location, wherein the target location is an area of the background image where the pixels in the background image have a highest degree of similarity to the pixels in the four corners of the bounding box;
placing the at least one of the selection of the augmented single-cells and the augmented multi-cells in the target location;
creating a cell masking image, wherein the cell masking image includes a black color background and a white area in the middle, wherein the white area is substantially the same shape as the at least one cell from the selection of the augmented single-cells and the augmented multi-cells; and
applying a Gaussian filter to smooth a transition between texture of the background image and texture of the at least one cell from the selection of the augmented single-cells and the augmented multi-cells.

12. The method of claim 11, wherein comparing pixels from four corners of the bounding box to pixels in the background image to determine the target location comprises using a mean Euclidean distance for determining similarity.

13. The method of claim 11, wherein the bounding box further comprises a height.

14. The method of claim 1, wherein the at least one augmentation technique applied to each cell corresponds to a particular augmentation policy of a pre-determined selection of a set of augmentation techniques.

15. The method of claim 14, wherein augmentation techniques of the pre-determined selection of the set of augmentation techniques are selected from FlipLR, FlipUD, AutoContrast, Equalize, Rotate, Posterize, Contrast, Brightness, Sharpness, Smooth, and Resize.

16. The method of claim 14, further comprising:
identifying the particular augmentation policy used for the at least one augmentation technique applied to each cell, wherein identifying the particular augmentation policy used for the at least one augmentation technique applied to each cell comprises: applying potential policies of combinations of augmentation techniques to a cell; scoring results of the application of the potential policies; ranking the scored results; and selecting a highest ranking one or more potential policies as the particular augmentation policy.

17. The method of claim 1, wherein extracting each instance of single-cells includes identifying each instance of single-cells in the image of eukaryotic cells, labelling each instance of single-cells as a single-cell, and storing each instance of single-cells in a single-cell resource.

18. The method of claim 1, wherein extracting each instance of multi-cells includes identifying each instance of multi-cell groupings in the image of eukaryotic cells, labelling each instance of multi-cells as a multi-cell, and storing each instance of multi-cells in a multi-cell resource.

19. The method of claim 1, wherein selecting the set of cells from the extracted single-cells and the extracted multi-cells comprises randomly selecting the cells.

20. The method of claim 1, wherein selecting the set of cells from the extracted single-cells and the extracted multi-cells comprises mimicking a distribution of the eukaryotic cells in the original image of eukaryotic cells.
